(19) United States
(12) Patent Application Publication
(10) Pub. No.: US 2026/0161121 A1
(43) Pub. Date: Jun. 11, 2026

(54) FIXING UNIT

(71) Applicant: CANON KABUSHIKI KAISHA, Tokyo (JP)

(72) Inventors: TAKASHI HIRAMATSU, Tokyo (JP); TAKAAKI AKAMATSU, Kanagawa (JP); KENICHI TAGAMI, Tokyo (JP)

(21) Appl. No.: 19/399,929

(22) Filed: Nov. 25, 2025

(30) Foreign Application Priority Data
Dec. 11, 2024 (JP) 2024-217047

(51) Int. Cl. G03G 15/20

(52) U.S. Cl. CPC G03G 15/2032; G03G 15/206; G03G 15/2064; G03G 2215/2035

(57) ABSTRACT

A fixing unit includes an endless belt, a heater, a pressure roller including a roller portion formed of rubber, and a frame formed of resin. The frame includes a base surface that faces an outer surface of the roller portion. The base surface includes a first rib and a second rib. The first rib is formed with a first shape. The second rib is formed with a second shape. The first shape is a first through hole that penetrates the first rib in the longitudinal direction, or a first groove portion that is formed in a part of the circular arc shape of the first rib. The second shape is a second through hole that penetrates the second rib in the longitudinal direction, or a second groove portion that is formed in a part of the circular arc shape of the second rib.

### BACKGROUND

### Field of the Technology

This disclosure relates to a fixing unit to be mounted to an image forming apparatus of an electrophotographic system.

### Description of the Related Art

A fixing unit described in Japanese Patent Laid-Open No. 2024-31208 includes a heating unit equipped with a heater that heats an inner surface of a belt, and a pressure roller that forms a nip portion by sandwiching the belt with the heater, thereby, toner on a recording material is fixed.

### SUMMARY

An aspect of the present disclosure provides a fixing unit including an endless belt, a heater configured to heat an inner surface of the belt, a pressure roller including a roller portion formed of rubber and configured to form a nip portion by sandwiching the belt with the heater such that a recording material is conveyed in a conveyance direction through the nip portion, and a frame formed of resin, configured to support the pressure roller rotatably, and disposed to face the roller portion over a longitudinal direction of the pressure roller, wherein the frame includes a base surface that faces an outer surface of the roller portion over the longitudinal direction, wherein the base surface includes a first rib and a second rib that extend in an intersecting direction intersecting both the conveyance direction and the longitudinal direction, wherein, when viewed in the longitudinal direction, a tip portion of the first rib and a tip portion of the second rib each have a circular arc shape along the outer surface of the roller portion, wherein the first rib and the second rib are aligned in the longitudinal direction, wherein the first rib is formed with a first shape, wherein the second rib is formed with a second shape, wherein the first shape is a first through hole that penetrates the first rib in the longitudinal direction, or a first groove portion that is formed in a part of the circular arc shape of the first rib, and wherein the second shape is a second through hole that penetrates the second rib in the longitudinal direction, or a second groove portion that is formed in a part of the circular arc shape of the second rib.

Another aspect of the present disclosure provide a fixing unit including an endless belt, a heater configured to heat an inner surface of the belt, a pressure roller including a roller portion formed of rubber and configured to form a nip portion by sandwiching the belt with the heater such that a recording material is conveyed in a conveyance direction through the nip portion, and a frame formed of resin, configured to support the pressure roller rotatably, and disposed to face the roller portion over a longitudinal direction of the pressure roller, wherein the frame includes a base surface that faces an outer surface of the roller portion over the longitudinal direction, wherein the base surface includes a first rib and a second rib that extend in an intersecting direction intersecting both the conveyance direction and the longitudinal direction, wherein, when viewed in the longitudinal direction, a tip portion of the first rib and a tip portion of the second rib each have a circular arc shape along the outer surface of the roller portion, wherein the first rib and the second rib are aligned in the longitudinal direction, wherein the base surface includes a first intersecting rib having a first shape and a second intersecting rib having a second shape, wherein the first intersecting rib and the second intersecting rib are disposed between the first rib and the second rib in the longitudinal direction and extend in the longitudinal direction and in the intersecting direction, wherein the first intersecting rib and the second intersecting rib are disposed at different positions in the conveyance direction, wherein the first shape is a first through hole that penetrates the first intersecting rib in the conveyance direction, or a groove portion that is formed in a tip portion of the first intersecting rib in the intersecting direction, and wherein the second shape is a second through hole that penetrates the second intersecting rib in the conveyance direction, or a groove portion that is formed in a tip portion of the second intersecting rib in the intersecting direction.

Another aspect of the present disclosure provide a fixing unit including an endless belt, a heater configured to heat an inner surface of the belt, a pressure roller including a roller portion formed of rubber and configured to form a nip portion by sandwiching the belt with the heater such that a recording material is conveyed in a conveyance direction through the nip portion, a frame formed of resin, configured to support the pressure roller rotatably, and disposed to face the roller portion over a longitudinal direction of the pressure roller, and a temperature detection unit by which a temperature of the pressure roller is detected, wherein the frame includes a base surface that faces the roller portion over an intersecting direction intersecting both the conveyance direction and the longitudinal direction, wherein the base surface includes a first rib and a second rib that extend in the intersecting direction, wherein, when viewed in the longitudinal direction, a tip portion of the first rib and a tip portion of the second rib each have a circular arc shape along an outer surface of the roller portion, wherein the first rib and the second rib are aligned in the longitudinal direction, wherein the frame is formed with a through hole that penetrates from the base surface to an exterior of the frame and that is positioned between the first rib and the second rib, and wherein the temperature detection unit is disposed to penetrate the through hole and face the pressure roller.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a cross-sectional view in a short direction of a lower frame and a pressure roller of a fixing unit according to Example1.

FIG. 2 is a cross-sectional view illustrating an image forming apparatus according to an embodiment.

FIG. 3 is a cross-sectional view illustrating a fixing unit according to the embodiment.

FIG. 4 is a cross-sectional view illustrating the fixing unit according to the embodiment.

FIG. 5 is an exploded perspective view illustrating the fixing unit according to the embodiment.

FIG. 6A is a front view illustrating the fixing unit according to the embodiment.

FIGS. 6B to 6D are cross-sectional views illustrating the fixing unit according to the embodiment.

FIGS. 7A and 7B are cross-section views illustrating the fixing unit according to the embodiment.

FIG. 8 is an exploded perspective view illustrating the fixing unit according to the embodiment.

FIG. 9 illustrates a cross-sectional view in a longitudinal direction of the lower frame and the pressure roller in Example 1.

FIGS. 10A and 10B are diagrams illustrating conveyance-direction ribs in Example 1.

FIGS. 10C to 10F are diagrams illustrating conveyance-direction ribs in modification examples.

FIG. 11A illustrates a cross-sectional view in the longitudinal direction of a lower frame and the pressure roller in Example 2.

FIG. 11B is a diagram illustrating through holes of a longitudinal-direction rib in a modification example.

FIG. 12A is a perspective view illustrating a lower frame in Example 3.

FIG. 12B is an enlarged view of a part of the lower frame in Example 3.

FIG. 13 is a bottom view illustrating a lower frame in Example 4.

FIG. 14 is a front view illustrating a lower frame in Modification Example 1 of Example 4.

FIG. 15 is a rear view illustrating a lower frame in Modification Example 2 of Example 4.

FIG. 16 is a front view illustrating a lower frame in Modification Example 3 of Example 4.

FIG. 17 is a perspective view illustrating a lower frame in Example 5.

FIG. 18 is a schematic diagram illustrating a cross-section in the short direction of the lower frame and the pressure roller in Example 5.

FIG. 19 is a schematic diagram illustrating a cross-section in the short direction of a lower frame and the pressure roller in a modification example of Example 5.

FIGS. 20A and 20B are diagrams illustrating examples of thermistor arrangement in Example 5.

### DESCRIPTION OF THE EMBODIMENTS

Hereinafter, with reference to drawings, embodiments according to this disclosure will be described.

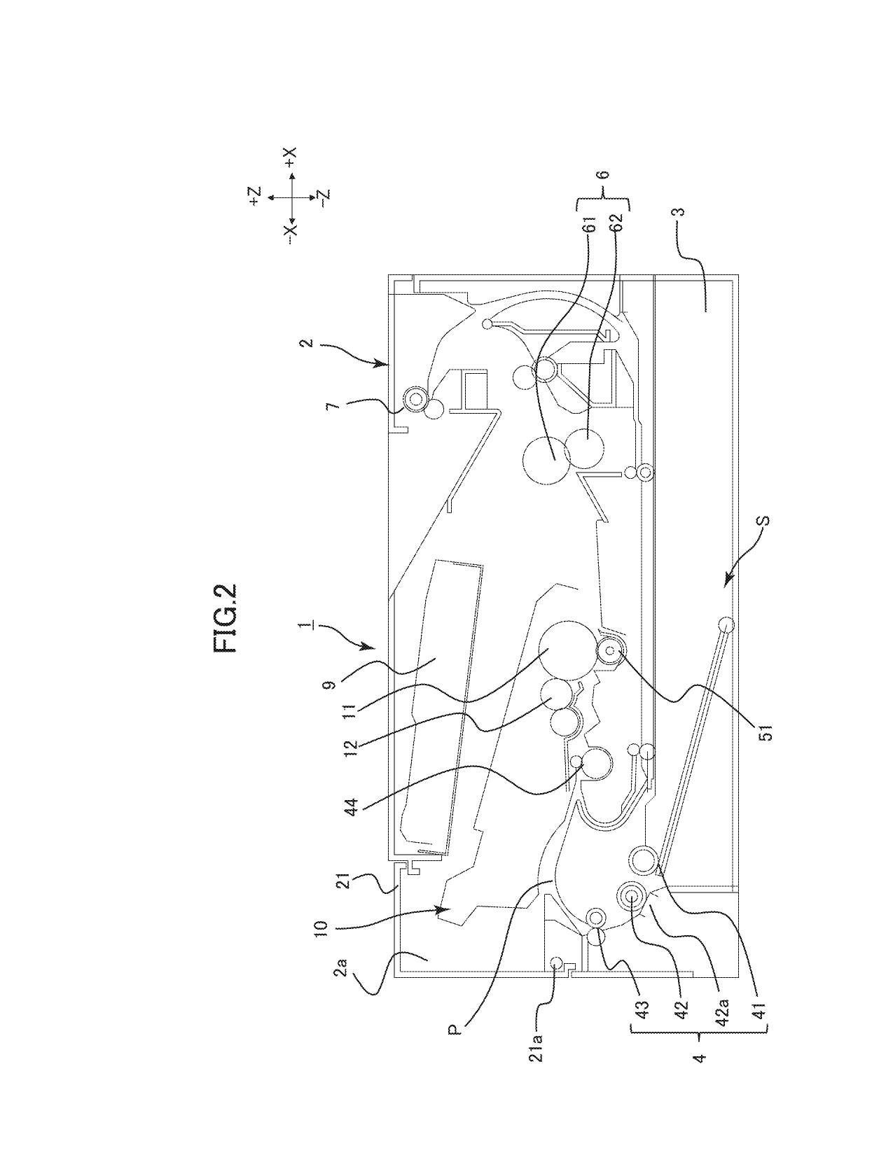

FIG. 2 is a cross-sectional view illustrating an image forming apparatus 1 that includes a fixing unit 6, serving as a fixing unit according to one embodiment. In the following description, as illustrated in FIG. 2, a vertical direction when the image forming apparatus 1 is installed on a horizontal plane is referred to as a Z direction. A direction intersecting the Z direction is referred to as a Y direction. The Y direction corresponds to a rotational axis direction of a pressure roller 62, described below. A direction intersecting both the Z and Y directions is referred to as an X direction. The X direction corresponds to a direction parallel to a direction in which a heating unit 61, described below, conveys a recording material positioned at a nip portion. The X and Y directions may preferably be horizontal directions. In addition, the X, Y, and Z directions may preferably intersect orthogonally to each other.

In addition, as necessary, arrows X, Y, and Z directions illustrated in each diagram are respectively referred to as +X, +Y, and +Z directions, and the opposite directions are respectively referred to as -X, -Y, and -Z directions. In the following description, a direction in which a sheet S, serving as the recording material, is conveyed at the nip portion np1, described below, is referred to as a sheet conveyance direction D1. The sheet conveyance direction D1 in an embodiment of FIG. 2 is a direction along the +X direction. In addition, the rotational axis direction of the pressure roller 62 is sometimes referred to as an axial direction, a longitudinal direction of the fixing unit 6, or simply “a longitudinal direction”. In the axial direction, a direction from an end on one side of the pressure roller 62 toward an end on the other side is referred to as a first axial direction (+Y direction). In the axial direction, a direction opposite to the first axial direction is referred to as a second axial direction (-Y direction). The Y direction is also the longitudinal direction of the fixing unit 6. In addition, the Y direction is a longitudinal direction or a generatrix direction of a belt 614.

### Image Forming Apparatus

Using FIG. 2, a configuration of the image forming apparatus 1 will be described. The image forming apparatus 1 includes an apparatus body 2, a process cartridge 10, and the fixing unit 6. The process cartridge 10 is detachably attached with respect to the apparatus body 2. The fixing unit 6 is detachably attached with respect to the apparatus body 2. It can also be said that the fixing unit 6 is mounted with respect to the apparatus body 2. To be noted, the fixing unit 6 may be attached in a non-detachable manner.

The apparatus body 2 includes a feed tray 3, a sheet feeding unit 4, a conveyance path P, a transfer roller 51, a sheet discharge unit 7, a discharge tray 8, a laser scanner 9, and an opening/closing door 21. The process cartridge 10 includes a photosensitive drum 11, and a developing roller 12, serving as a developer bearing member. In addition, the process cartridge 10 internally stores developer. The opening/closing door 21 is pivotably supported around a pivot shaft 21a as a center, and is configured to move between a closed position closing an opening portion 2a and an open position opening the opening portion 2a. In a case where the opening/closing door 21 is positioned at the open position at which the opening portion 2a is opened, it is possible to attach and detach the process cartridge 10 with respect to the apparatus body 2 via the opening portion 2a.

The sheet feeding unit 4 includes a feed roller 41, a separation roller 42, a separation pad 42a, and a conveyance roller pair 43. Based on a print start signal, the sheet S stored in the feed tray 3 is sent to the conveyance path P by the sheet feeding unit 4, and is conveyed to the transfer roller 51 via a registration roller pair 44.

When the sheet S is conveyed to a predetermined position, an image formation start signal is transmitted, and an image formation process is started. The photosensitive drum 11, which is rotatably driven by a drive source (motor), not shown, is uniformly charged to a predetermined potential by a charging means, not shown. With respect to a surface of the photosensitive drum 11 which has been charged, exposure is performed by the laser scanner 9 based on image information, and an electrostatic latent image in which a charge is removed from exposure areas is formed. The toner within the process cartridge 10 is borne by the developing roller 12, and is supplied to the photosensitive drum 11 in accordance with the electrostatic latent image; thereby the latent image is developed. As a result, the latent image is visualized on the photosensitive drum 11 as a toner image.

The transfer roller 51 is arranged to face the photosensitive drum 11 included in the process cartridge 10. When the sheet S, conveyed by the registration roller pair 44, passes through a nip portion between the photosensitive drum 11 and the transfer roller 51, voltage is applied to the transfer roller 51 from the apparatus body 2, and the toner image on the photosensitive drum 11 is transferred onto the sheet S as an unfixed image. Thereafter, the sheet S onto which the toner image has been transferred is conveyed to the fixing unit 6 equipped with the heating unit 61 and the pressure roller 62. The fixing unit 6 is a fixing unit that fixes the toner (developer) onto the recording material. When the sheet S passes through the nip portion of the heating unit 61 and the pressure roller 62, the unfixed image transferred onto the sheet S is heated and pressurized, and is fixed on a surface of the sheet S. The sheet S on which the toner image has been fixed is discharged via the sheet discharge unit 7 to the discharge tray 8.

### Fixing Unit

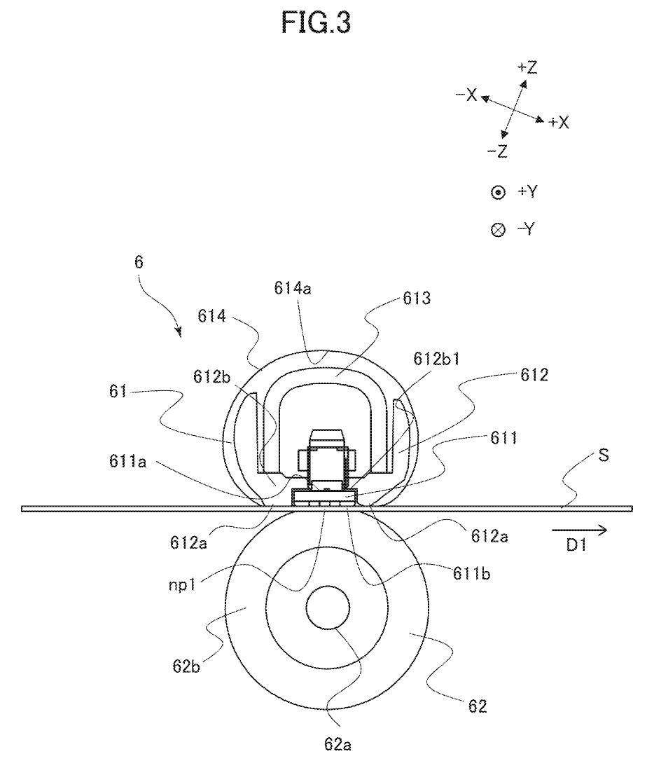

Next, a configuration of the fixing unit 6 will be described. FIG. 3 is a plan view illustrating the fixing unit 6. As described in detail below, the fixing unit 6 includes the endless belt 614, and a heater 611 that heats an inner surface of the belt 614. In addition, the fixing unit 6 includes the pressure roller 62 including a rubber roller portion 62b that forms the nip portion np1 by sandwiching the belt 614 with the heater 611, so that the recording material is conveyed in a conveyance direction (sheet conveyance direction D1) through the nip portion np1. In addition, the fixing unit 6 includes a resin frame (lower frame 63) which rotatably supports the pressure roller 62 and faces the roller portion 62b over the longitudinal direction of the pressure roller 62.

As illustrated in FIG. 3, the heating unit 61 includes the heater 611, a holder 612, a stay 613, and the belt 614. The heater 611 is disposed on an inner surface side of the belt 614, and heats the belt 614. The heater 611 extends in the longitudinal direction (Y direction) of the belt 614, and has a planar plate shape. The heater 611 includes a first surface 611a and a second surface 611b on a side opposite to the first surface 611a, and the first surface 611a is supported by the holder 612.

The holder 612 is formed of a heat resistant resin such as polyphenylene sulfide (PPS) or liquid crystal polymer, and includes a guide surface 612a and support walls 612b. The guide surface 612a guides the belt 614 by coming into contact with the inner surface 614a of the belt 614, and the support walls 612b include support surfaces 612b1 that support the heater 611. The support surfaces 612b1 of the support walls 612b come into contact with the first surface 611a of the heater 611. The stay 613 is a member that supports the holder 612, and is formed by bending a plate material possessing higher stiffness than the holder 612, such as a steel plate with a thickness of 1.6 millimeters (mm), into a substantially U-shaped configuration.

The belt 614 is a heating member (heating rotary member) that heats the image on the recording material. The belt 614 of this embodiment is an endless belt having heat resistance and flexibility, and is constituted by, for example, a metal sleeve such as stainless steel, coated with fluororesin, or a laminate of polyimide resin, silicone rubber, fluororesin, and the like. The belt 614 can also be referred to as a rotatable tubular film. The heater 611, the holder 612, and the stay 613 are arranged inside the belt 614, and the belt 614 is configured to rotate around these members. The inner surface 614a of the belt 614 comes into contact with the second surface 611b of the heater 611.

The pressure roller 62 includes a metallic shaft 62a and the roller portion 62b (outer circumferential portion) formed of an elastic substance covering the shaft 62a, and is pressed against the heater 611 via the belt 614. The pressure roller 62 forms the nip portion np1 for nipping to heat and pressurize the sheet S by nipping the belt 614 between itself and the heater 611. In other words, it can be said that the pressure roller 62 forms the nip portion np1 in conjunction with the heater 611 via the belt 614. That is, the pressure roller 62 is a rotary member that is used to heat and pressurize the sheet S in conjunction with the heater 611 at the nip portion np1. The nip portion np1 is a contact portion at which the belt 614 and the pressure roller 62 come into contact.

The pressure roller 62 is configured to rotate when a driving force from a drive source included in the image forming apparatus 1 is transmitted. When the pressure roller 62 rotates, the belt 614 rotates in synchronization with the pressure roller 62. The sheet S, onto which the toner image has been transferred, is conveyed between the pressure roller 62 and the heated belt 614, and, thereby, the toner image is thermally fixed.

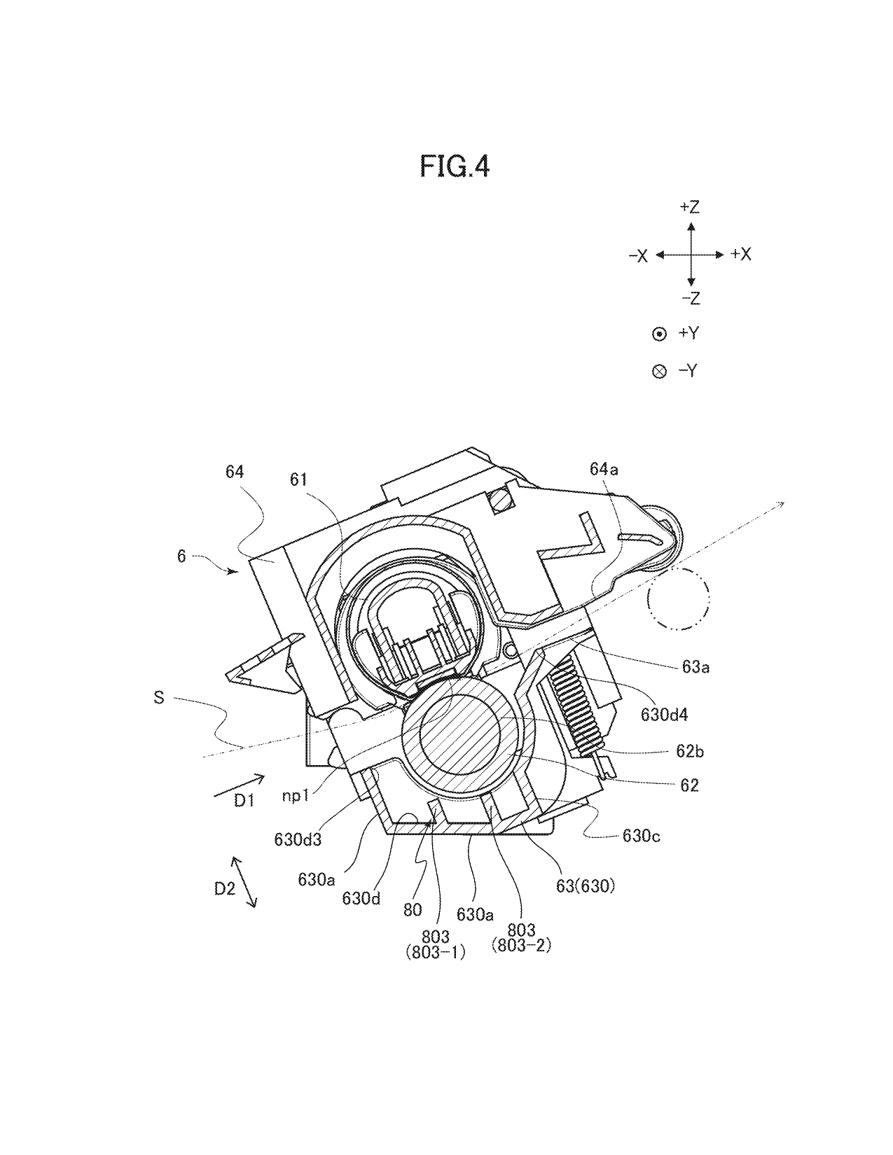

Next, using FIG. 4, a frame configuration of the fixing unit 6 will be described. FIG. 4 is a plan view illustrating the fixing unit 6. The fixing unit 6 includes an upper frame 64 and a lower frame 63. The upper and lower frames 64 and 63 form a frame body of the fixing unit 6. The lower and upper frames 63 and 64 can also be respectively referred to as a first frame and a second frame.

To be noted, the configuration of the lower frame 63 illustrated in FIGS. 4 to 8 is an example, and the detailed configuration of the lower frame 63 will be described in Examples described below.

The lower frame 63 is a frame that supports the heating unit 61 and the pressure roller 62. The upper frame 64 is positioned on top of the lower frame 63, and covers the heating unit 61. The lower and upper frames 63 and 64 are resin members, formed from a non-conductive molded member (resin member).

The upper frame 64 includes an upper guide surface 64a disposed further downstream than the heating unit 61 in the sheet conveyance direction D1. The upper guide surface 64a guides an upper surface of the sheet S conveyed in the sheet conveyance direction D1. The lower frame 63 includes a lower guide surface 63a disposed further downstream than the heating unit 61 in the sheet conveyance direction D1. The lower guide surface 63a guides a lower surface of the sheet S conveyed in the sheet conveyance direction D1.

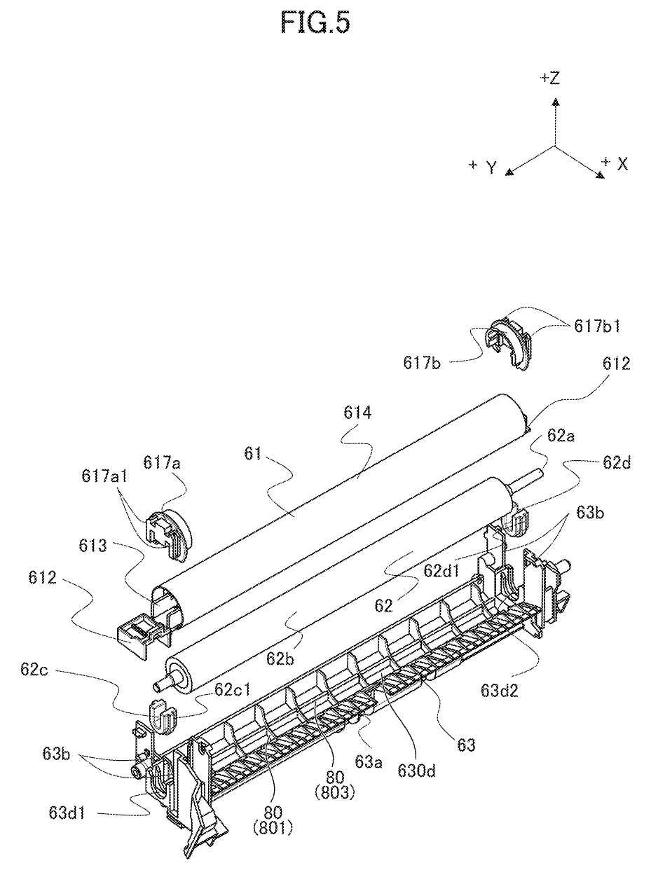

Next, using FIG. 5, the configuration of the lower frame 63 that supports the pressure roller 62 will be described. FIG. 5 is an exploded perspective view illustrating the fixing unit 6. The lower frame 63 includes rails 63b at each end portion of the first and second axial directions. The rails 63b extend in the vertical direction, and support the holder 612 in a manner allowing for vertical movement. The two rails 63b are each disposed to face in the axial direction. The rails 63b engage with groove portions 617a1 and 617b1 respectively disposed in transmission members 617a and 617b.

The fixing unit 6 includes bearings 62c and 62d. The end portions in the first and second axial directions of the shaft 62a are respectively supported by the bearings 62c and 62d. The bearing 62c is positioned by being fitted into a recessed portion 63d1 disposed in the lower frame 63. Similarly, the bearing 62d is positioned by being fitted into a recessed portion 63d2 disposed in the lower frame 63. To be noted, the bearing 62c possesses electrical conductivity. To be noted, in this configuration, projecting portions 62c1 and 62d1 are disposed in the bearings 62c and 62d, and the recessed portions 63d1 and 63d2 are disposed in the lower frame 63; however, the projecting-recessed relationship may be reversed. In addition, a securing portion securing the bearings 62c and 62d to the lower frame 63 is not limited to the projecting-recessed configuration.

### Pressurizing Mechanism

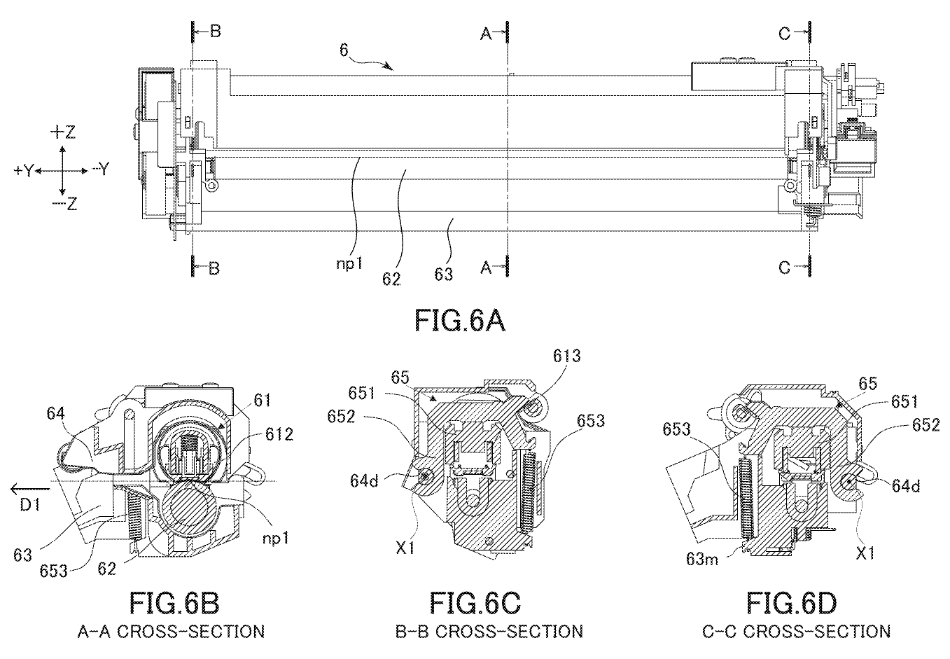

Next, a pressurizing mechanism of the fixing unit 6 will be described. FIG. 6A is a plan view illustrating the fixing unit 6. FIGS. 6B to 6D each are a cross-section view in the short direction of FIG. 6A. The cross-section in the short direction (short cross-section) of the fixing unit 6 refers to a cross-section of the fixing unit 6 taken along an imaginary plane perpendicular to the longitudinal direction (Y direction) of the fixing unit 6. In addition, the cross-section in the longitudinal direction (longitudinal cross-section) of the fixing unit 6, described below, refers to a cross-section of the fixing unit 6 taken along an imaginary plane parallel to the longitudinal direction (Y direction) of the fixing unit 6 (in particular, a plane including the rotational axis of the pressure roller 62).

As illustrated in FIGS. 6A to 6D, the fixing unit 6 includes pressurizing mechanisms 65 for pressurizing the nip portion np1. The pressurizing mechanisms 65 of this embodiment urge the heating unit 61 with respect to the pressure roller 62. The pressurizing mechanisms 65 are disposed at each end portion in the first and second axial directions of the lower frame 63. In other words, it can also be said that the pressurizing mechanisms 65 are supported by the lower frame 63. To be noted, the pressurizing mechanisms 65 disposed on the sides of the respective end portions in the first and second axial directions of the lower frame 63 are substantially the same in configuration. Accordingly, the description of the pressurizing mechanism 65 disposed on the side of the first axial direction also applies to the pressurizing mechanism 65 disposed on the side of the second axial direction; therefore, repetitive description will be omitted.

The pressurizing mechanism 65 includes a transmission member 651, a pressurizing arm 652, and a pressurizing spring 653. The pressurizing arm 652 is supported by the lower frame 63. In more particular, the pressurizing arm 652 is supported by a supporting portion 64d of the lower frame 63, and is pivotably supported around a center axis X1 of the supporting portion 64d. The supporting portion 64d is a substantially cylindrically shaped projection.

The pressurizing arm 652 moves the transmission member 651 in a downward direction by applying pressure to the transmission member 651 from above. Thereby, the transmission member 651 applies pressure to the stay 613 in the downward direction. The transmission member 651 applies pressure to the stay 613, and moves the stay 613 in the downward direction. When the stay 613 is moved in the downward direction, the heating unit 61, which includes the stay 613, is urged toward the pressure roller 62. The pressurizing spring 653 is an electrically conductive tension coil spring that urges the pressurizing arm 652 such that the heating unit 61 is pressed against the pressure roller 62. End portions 653a and 653b of the pressurizing spring 653 are engaged with part 63e1 of the lower frame 63 and part 652a of the pressurizing arm 652. When the pressurizing spring 653 urges the pressurizing arm 652, the pressurizing arm 652 moves the transmission member 651 in the downward direction. That is, the pressurizing arm 652 urges the heating unit 61 against the pressing roller 62.

### Pressure Release Mechanism

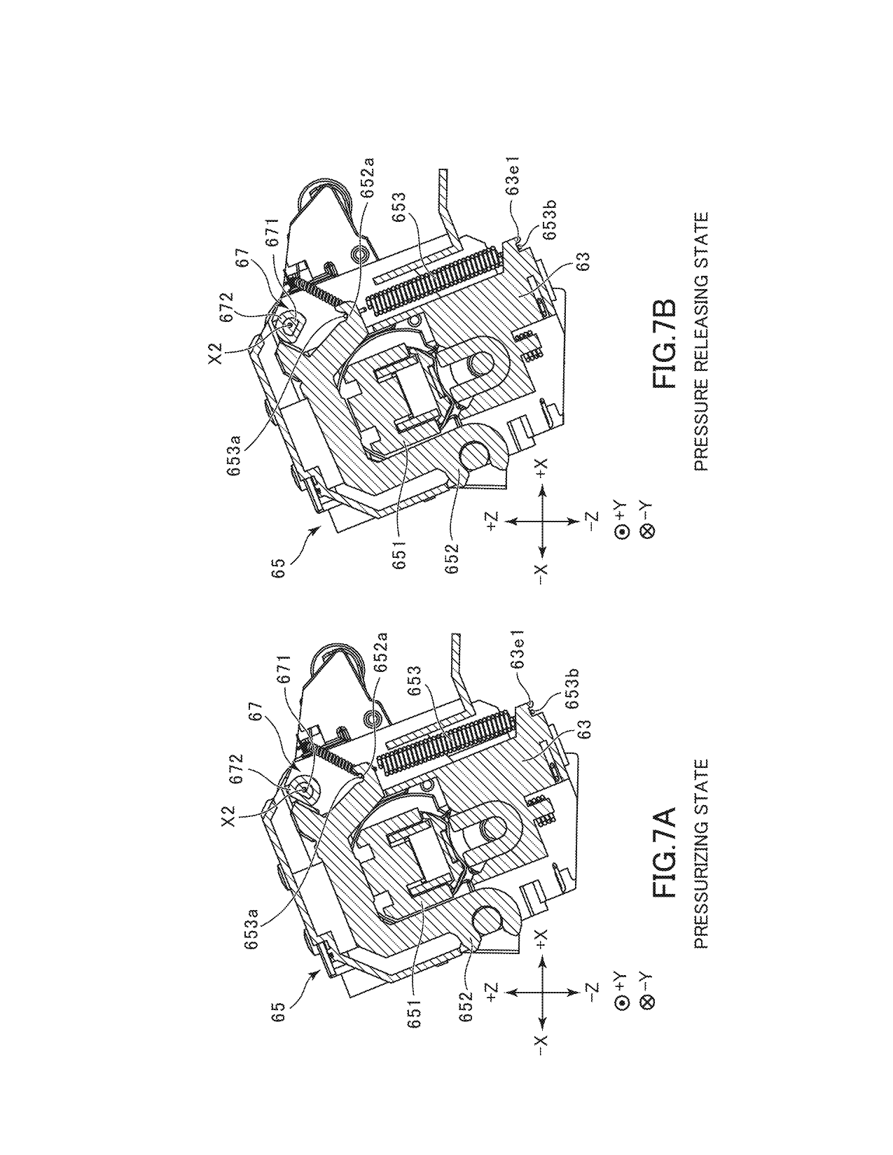

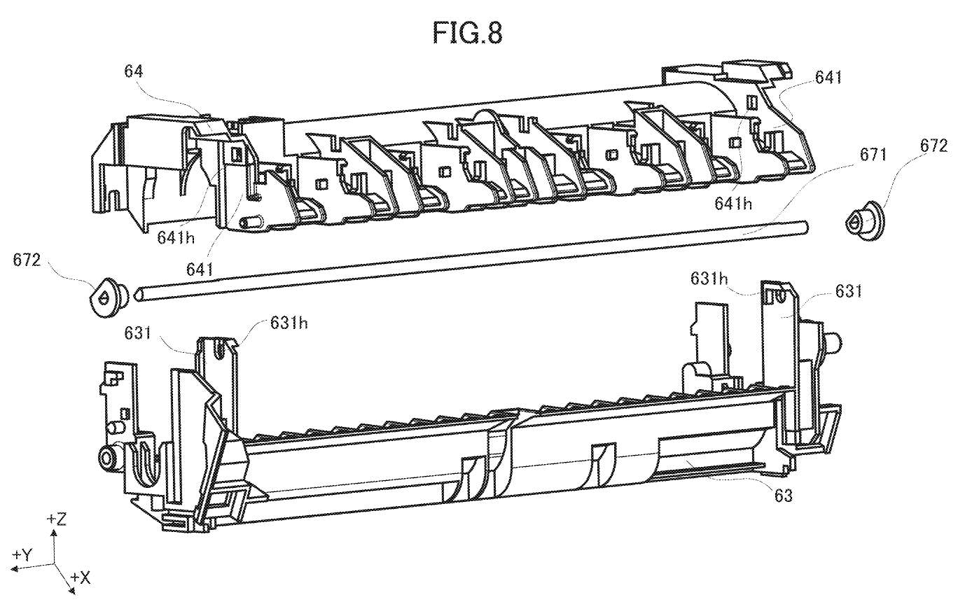

Next, using FIGS. 7A, 7B, and 8, the configuration of a pressure release mechanism provided in the fixing unit 6 will be described. FIGS. 7A and 7B are cross-sectional views in the short direction of the fixing unit 6. FIG. 7A illustrates a pressurizing state in which the pressure release mechanism 67 allows pressurization at the nip portion np1. FIG. 7B illustrates a pressure release state in which the pressure release mechanism 67 releases the pressurization at the nip portion np1. FIG. 8 illustrates an exploded perspective view of the upper and lower frames 64 and 63, and a cam shaft 671, with certain components such as the heating unit 61 and the pressure roller 62 omitted.

The pressure release mechanisms 67 are a pressure release mechanism that changes nip pressure between the heating unit 61 and the pressure roller 62 at the nip portion np1. The pressure release mechanisms 67 include the cam shaft 671 and cams 672.

As illustrated in FIGS. 7A and 7B, the cam shaft 671 can pivot around a center axis X2 as a center. The cam shaft 671 extends in the axial direction, and is fabricated from electrically conductive metal. As illustrated in FIG. 8, the cams 672 are secured (supported) to each of the respective end portions in the first and second axial directions of the cam shaft 671. The cams 672 are supported so as to rotate in conjunction with the cam shaft 671. The cams 672 are disposed on each side of the respective end portions in the first and second axial directions of the lower frame 63. The cams 672 disposed at the respective end portions in the first and second axial directions of the lower frame 63 are substantially the same in configuration.

The cams 672 apply pressure to the pressurizing arms 652 by resisting urging forces of the pressurizing spring 653. That is, by rotating the cams 672, the pressurizing force of the heating unit 61 against the pressure roller 62 applied by the pressurizing arm 652 is changed. The cam 672 can pivot between a pressurizing position illustrated in FIG. 7A and a pressure release position illustrated in FIG. 7B.

In a case of releasing the pressurizing state, the cams 672 rotate when the cam shaft 671 is rotated. When the cams 672 rotate, the pressurizing arms 652, which come into contact with the cams 672, move away from the transmission members 651 toward a direction opposite to a direction in which the stay 613 is urged against the transmission members 651. Thereby, the pressure applied by the heating unit 61 toward the pressure roller 62 is reduced.

Next, using FIG. 8, the support configuration of the cam shaft 671 will be described. The lower frame 63 includes support walls 631 that rotatably support the cam shaft 671. The support walls 631 extend in the vertical direction (Z direction). The support wall 631 includes a hole 631h that pivotably supports the cam shaft 671. The cam shaft 671 passes through the holes 631h. In other words, the support walls 631 may also be referred to as shaft support portions that support the cam shaft 671. To be noted, the support walls 631 are disposed on each side of the respective end portions in the first and second axial directions of the lower frame 63. In addition, substantially identical holes 631h are disposed in the respective support walls 631.

The upper frame 64 includes support walls 641 that pivotably support the cam shaft 671. The support walls 641 extend in the vertical direction. The support wall 641 includes a hole 641h that pivotably supports the cam shaft 671. The cam shaft 671 passes through the holes 641h. To be noted, the support walls 641 are disposed on each side of the respective end portions in the first and second axial directions of the lower frame 63. In addition, the substantially identical holes 641h are disposed in the respective support walls 641.

### Example 1

The fixing unit 6 according to Example 1, which is an example of this embodiment, will be described. In this Example, a configuration for reducing effects caused by water vapor generated from the recording material in the fixing unit 6, which includes a plurality of ribs extending in the sheet conveyance direction D1, is proposed.

### Effects of Water Vapor Generated from Sheet

First, the effects of the water vapor generated from the sheet S during passage through the nip portion np1 of the fixing unit 6 will be described. In particular, in a high-temperature, high-humidity environment, paper, serving as the sheet S, placed on the feed tray 3 contains a substantial quantity of moisture. When this moisture laden paper passes through the nip portion np1, since the paper is also heated in conjunction with the toner image, the water vapor is generated from the paper. When the generated water vapor causes condensation on a surface of the pressure roller 62, a frictional force with the sheet S decreases, and image distortion may occur due to the slippage of the sheet S. In addition, due to partial changes in the frictional force resulting from the condensation, a conveyance force, which is applied to the sheet S by the pressure roller 62, may be brought into a state in which the conveyance force varies depending on a position in the longitudinal direction, and, as a result, may induce the formation of wrinkles in the sheet S.

### Reinforcement Rib of Lower Frame

Next, the shape and arrangement of a reinforcement rib 80 disposed in the lower frame (frame) 63 in this Example will be described.

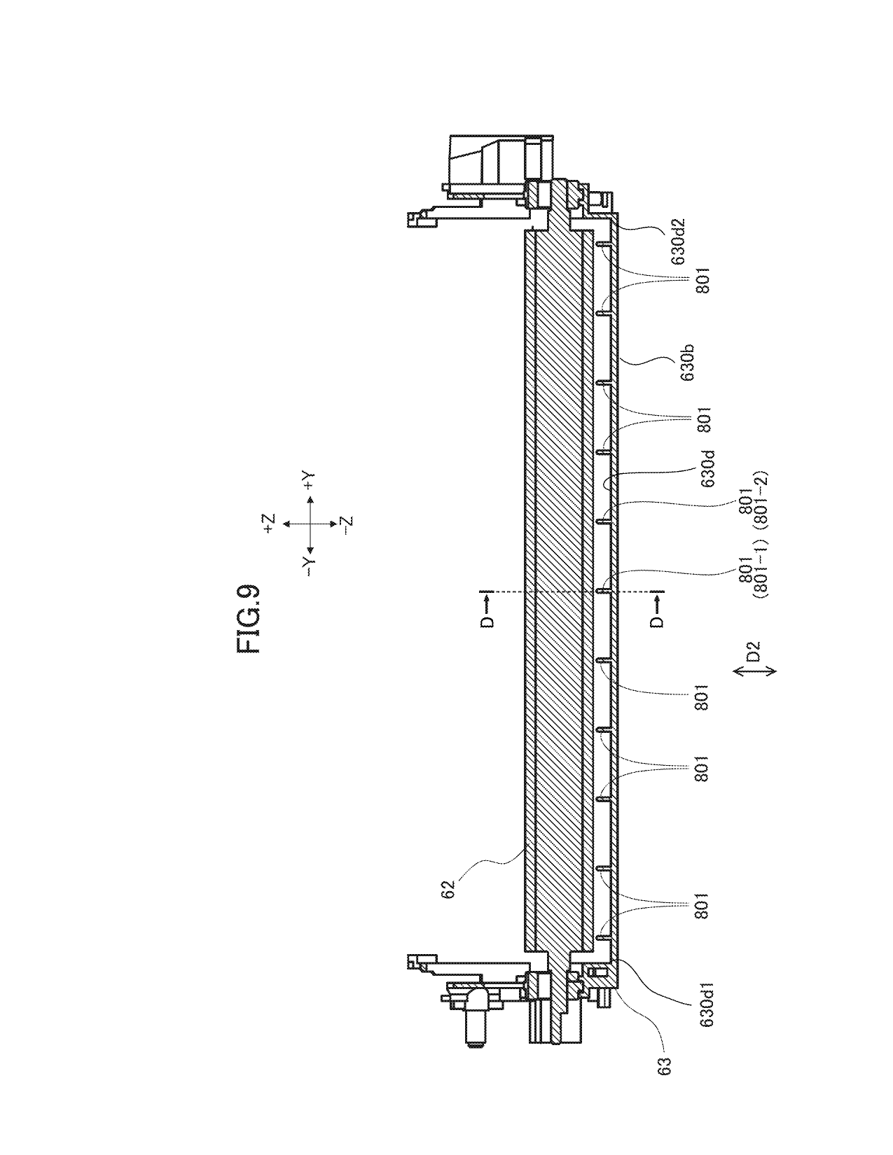

FIG. 9 is a cross-sectional view illustrating a longitudinal cross-section of the lower frame 63 with the pressure roller 62 mounted. As illustrated in FIGS. 4, 5, and 9, one or more reinforcement ribs 80 is disposed on the lower frame 63.

The lower frame 63 includes a base surface 630d, a front surface 630a facing upstream in the sheet conveyance direction D1, a bottom surface 630b facing downward, a rear surface 630c facing downstream in the sheet conveyance direction D1, and the reinforcement rib 80.

The base surface 630d refers to the reverse surfaces (inner surface of the lower frame 63) of the front, bottom, and rear surfaces 630a, 630b, and 630c, which are surfaces each facing the exterior of the lower frame 63. The base surface 630d is positioned to face the outer peripheral surface (outer surface) of the roller portion 62b of the pressure roller 62. As illustrated in FIG. 4, when viewed in the longitudinal direction, at least part of the pressure roller 62 is housed within a space surrounded by the base surface 630d.

The reinforcement rib 80 is provided on the base surface 630d to extend in an intersecting direction D2. In other words, the reinforcement rib 80 is formed to project from the base surface 630d toward a direction approaching the outer peripheral surface of the pressure roller 62. The intersecting direction D2 is a direction intersecting both the longitudinal direction (Y direction) of the pressure roller 62 and the sheet conveyance direction D1. The intersecting direction D2 may be a direction perpendicularly intersecting both the longitudinal direction (Y direction) of the pressure roller 62 and the sheet conveyance direction D1.

The base, front, bottom, and rear surfaces 630d, 630s, 630c, and 630c constitute a main body portion 630 of the lower frame 63 extending in the longitudinal direction. It can be said that the reinforcement rib 80 is supported by the main body portion 630. The reinforcement rib 80 and the main body portion 630 are integrally formed from a resin material.

The lower frame 63 of this Example includes equal to or more than one conveyance-direction rib 801, serving as the reinforcement rib 80. In the example illustrated in FIG. 9, the lower frame 63 includes a plurality of conveyance-direction ribs 801. In other words, the term “frame” in this Example includes a first rib and a second rib. An example of the first rib is one of the plurality of conveyance-direction ribs 801 (for example, a conveyance-direction rib 801-1 in FIG. 9), and an example of the second rib is another one of the plurality of conveyance-direction ribs 801 (for example, a conveyance-direction rib 801-2 in FIG. 9).

In this Example, the plurality of conveyance-direction ribs 801 are arranged at substantially equal intervals in the longitudinal direction. It can be said that the plurality of conveyance-direction ribs 801 include the first rib (conveyance-direction rib 801-1) and the second rib (conveyance-direction rib 801-2) aligned in the longitudinal direction.

One side of end portions in the longitudinal direction of the base surface 630d is referred to as a first end portion 630d1, and the other side of the end portions is referred to as a second end portion 630d2 (FIG. 9). In the longitudinal direction, the first rib (conveyance-direction rib 801-1) is closer to the first end portion 630d1 than the second end portion 630d2, and the second rib (conveyance-direction rib 801-2) is closer to the second end portion 630d2 than the first end portion 630d1. In other words, the first and second ribs may be arranged opposite to each other with the center of the base surface 630d in the longitudinal direction interposed between them.

The lower frame 63 may include a longitudinal-direction rib 803 (FIGS. 4 and 5) extending in the longitudinal direction (Y direction). In other words, the reinforcement rib 80 may include equal to or more than one conveyance-direction rib 801 and equal to or more than one longitudinal-direction rib 803. To be noted, in this Example, the reinforcement rib 80 may be constituted only by the conveyance-direction rib 801 without including the longitudinal-direction rib 803.

The longitudinal-direction rib 803 is, for example, formed to extend at least over the whole length of the roller portion 62b of the pressure roller 62. The longitudinal-direction rib 803 may be formed to extend over the whole area in the longitudinal direction of the base surface 630d. In addition, the longitudinal-direction rib 803 is formed to intersect each of the plurality of conveyance-direction ribs 801.

The reinforcement rib 80 supplements the stiffness of the lower frame 63 formed by a molded member. By increasing the stiffness by means of the reinforcement rib 80, it is possible to prevent the deflection of the lower frame 63 caused by heat, which is generation from the heating unit 61 and the pressure roller 62, as well as loads applied via the pressurizing mechanisms 65, and, further, it is possible to prevent creep deformation due to extended operational duration.

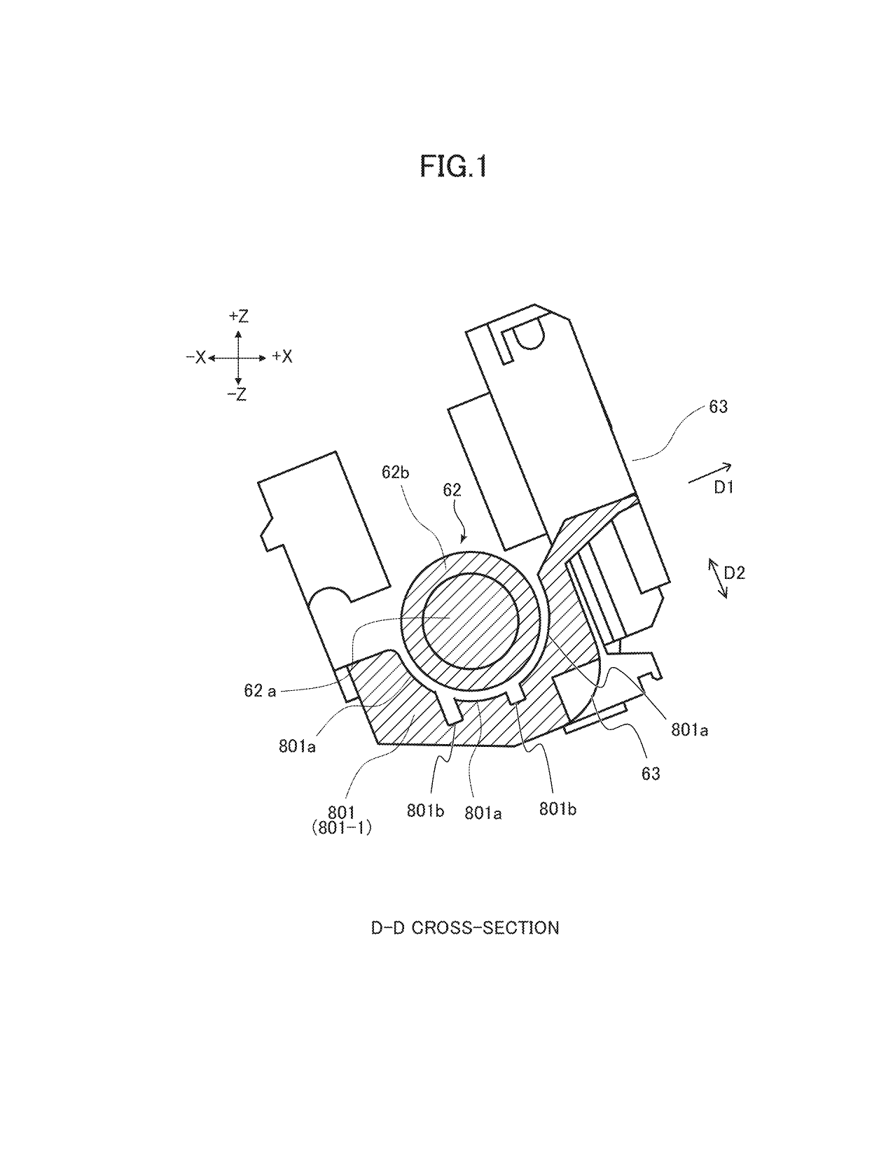

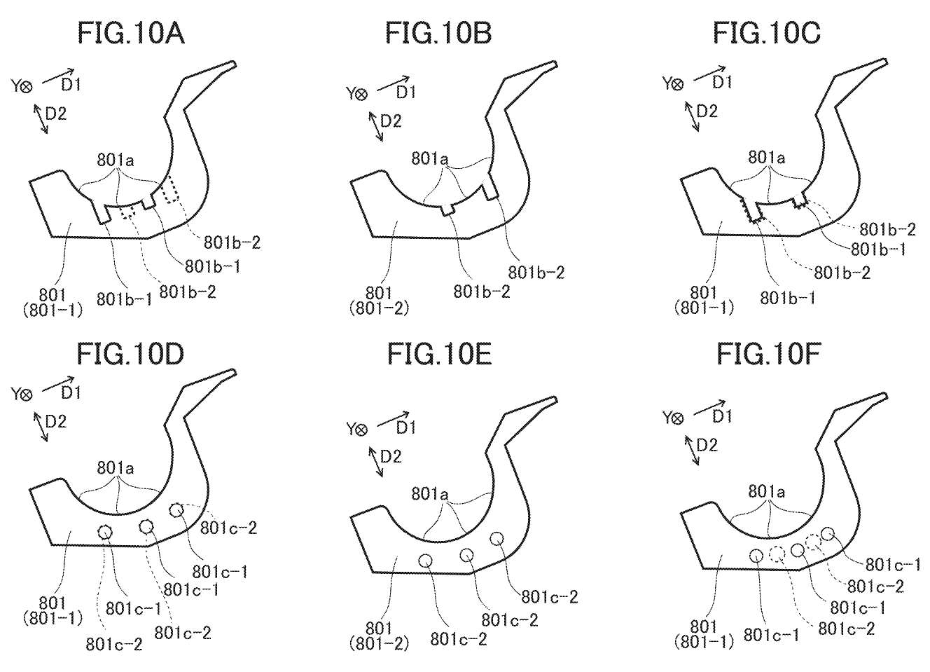

FIG. 1 illustrates a short direction cross-section of the lower frame 63 with the pressure roller 62 mounted, and is a cross-sectional view illustrating a cross-section taken along an imaginary plane passing through the conveyance-direction rib 801 (801-1) (the D-D cross-section in FIG. 9). FIG. 10A is a diagram illustrating the one conveyance-direction rib 801-1 as viewed in the longitudinal direction. FIG. 10B is a diagram illustrating another conveyance-direction rib 801-2 as viewed in the longitudinal direction.

As illustrated in FIG. 1, a tip portion 801a (ridge portions) of each conveyance-direction rib 801 in this Example is configured in a circular arc shape along the outer peripheral surface of the pressure roller 62.

### Groove Portion of Reinforcement Rib

A groove portion 801b is disposed at least one of the conveyance-direction ribs 801. The groove portion 801b is formed in a part of the circular arc shape of the tip portion 801a, and is a groove portion (recessed portion) that is recessed toward a side further away from the rotational axis of the pressure roller 62 as compared to the circular arc shape of the tip portion 801a.

A groove portion 801b-1 (FIG. 10A) disposed in the conveyance-direction rib 801-1 (first rib) is an example of a first groove portion, and a groove portion 801b-2 (FIG. 10B) disposed in the conveyance-direction rib 801-2 (second rib) is an example of a second groove portion. In addition, the groove portion 801b-1 disposed in the conveyance-direction rib 801-1 (first rib) is an example of a first shape, and the groove portion 801b-2 disposed in the conveyance-direction rib 801-2 (second rib) is an example of a second shape.

The groove portion 801b establishes communication among small spaces that are formed between the outer peripheral surface of the heating roller 62 and the base surface 630d of the lower frame 63 and are partitioned by the conveyance-direction ribs 801. In other words, the groove portion 801b forms a path that allows air containing the water vapor to move in the longitudinal direction.

To be noted, airflow passing through the groove portion 801b in the longitudinal direction may be actively generated by blower fans mounted in the apparatus body 2.

### Function of Groove Portion

If the small spaces partitioned by the conveyance-direction ribs 801 are configured to have high airtightness (minimal air transfer between adjacent spaces), there is a possibility that the air may stagnate within the small spaces. If the air stagnates within the small spaces, the water vapor generated from the sheet S during the image fixation may accumulate, and the condensation may occur on the pressure roller 62; thus, there is a possibility of the occurrence of the aforementioned adverse effects.

By disposing the groove portion 801b at the tip portion 801a of the conveyance-direction rib 801 as described in this Example, the stagnation of the air is suppressed, and it is possible to suppress the occurrence of the condensation on the pressure roller 62 even in environments such as the high-temperature, high-humidity environment where the sheet S contains a large amount of moisture. In other words, by the airflow passing through the groove portion 801b in the longitudinal direction, the water vapor generated from the sheet S during the image fixation can be expelled from an area adjacent to the outer peripheral surface of the pressure roller 62.

FIGS. 10A and 10B are diagrams illustrating the conveyance-direction ribs 801-1 and 801-2 that are adjacent to each other in the longitudinal direction. In the longitudinal direction, the conveyance-direction ribs 801-1 and 801-2 (first and second ribs) are disposed to face each other (FIG. 9).

In the illustrated example, two groove portions 801b-1 are formed in the first conveyance-direction rib 801-1 (FIG. 10A), and two groove portions 801b-2 are formed in the second conveyance-direction rib 801-2 (FIG. 10B). The number of groove portions 801b formed in the conveyance-direction ribs 801-1 and 801-2 may be different from each other.

In the examples illustrated in FIGS. 10A and 10B, when viewed in the longitudinal direction (Y direction), the groove portions 801b-1 formed in the first conveyance-direction rib 801-1 and the groove portions 801b-2 formed in the second conveyance-direction rib 801-2 do not overlap. To be noted, the dashed lines illustrated in FIG. 10A represent the transparently projected positions of the groove portions 801b-2 of the second conveyance-direction rib 801-2 on the first conveyance-direction rib 801-1, as viewed in the longitudinal direction (Y direction). As described above, by arranging the groove portions 801b between the conveyance-direction ribs 801-1 and 801-2, which are adjacent to each other, such that they do not overlap each other, it is possible to uniformly discharge the water vapor within the small space between the conveyance-direction ribs 801 which are adjacent to each other.

On the other hand, contrary to the examples of FIGS. 10A and 10B, when viewed in the longitudinal direction (Y direction), the groove portions 801b may be arranged to overlap each other between the conveyance-direction ribs 801-1 and 801-2, which are adjacent to each other. FIG. 10C illustrates an example of an arrangement in which the groove portions 801b-1 of the first conveyance-direction rib 801-1 and the groove portions 801b-2 of the second conveyance-direction rib 801-2 overlap when viewed in the longitudinal direction (Y direction). In this case, the airflow in the longitudinal direction becomes smoother, and, thereby, an amount of the air passing through the space between the outer peripheral surface of the pressure roller 62 and the lower frame 63 can be increased. Whether to arrange the groove portions 801b to overlap or not to overlap when viewed in the longitudinal direction can be modified in accordance with a specific configuration of the fixing unit 6 (particularly, the design of airflow paths), positions of blower fans, or the like.

An area of the groove portion 801b of the conveyance-direction rib 801 on a downstream side in a direction of airflow generated by a blower fan may be configured larger than an area of the groove portion 801b of the conveyance-direction rib 801 on an upstream side. In this case, for example, air can be discharged more smoothly as compared to a case where the area of the groove portion 801b of the conveyance-direction rib 801 on the downstream side is configured smaller, and the stagnation of the water vapor can be prevented more efficiently.

### Modification Examples

To be noted, in this Example, as the examples of the first and second groove portions, the groove portions 801b have a rectangular shape, and extend in an elongated manner with respect to a direction perpendicular to the sheet conveyance direction D1; however, the shape of the groove portion 801b is not limited to this, and, for example, it is acceptable to form the groove portion 801b in a semicircular shape when viewed in the longitudinal direction. In addition, in FIG. 1, two groove portions 801b are formed in one conveyance-direction rib 801; however, a single groove portion 801b or equal to or more than three groove portions 801b may be formed. In a case where there are a plurality of the conveyance-direction ribs 801, the groove portions 801b may be formed in only certain of the conveyance-direction ribs 801.

In this Example, as the examples of the first and second shapes, the groove portions 801b (first and second groove portions) are disposed to suppress the stagnation of the water vapor; however, as illustrated in FIGS. 10D and 10E, instead of the groove portions 801b, through holes 801c may be formed in the conveyance-direction rib 801. In other words, a hole penetrating in the longitudinal direction (Y direction) may be formed in the conveyance-direction rib 801 at a portion closer to a root side (base surface 630d side) than the tip portion 801a. By forming the through hole 801c in the conveyance-direction rib 801, the air transfer between the small spaces partitioned by the conveyance-direction ribs 801 is facilitated, and, thereby, it is possible to assist in the discharge of the water vapor.

FIG. 10D is a diagram illustrating an example of the first conveyance-direction rib 801-1 (first rib) in which through holes 801c-1 (first through holes) are formed. FIG. 10E is a diagram illustrating an example of the second conveyance-direction rib 801-2 (second rib) in which through holes 801c-2 (second through holes) are formed. In a case where, as illustrated in FIG. 10D, the through holes 801c-1 (first through holes, first shapes) overlap the through holes 801c-2 (second through holes, second shapes) when viewed in the longitudinal direction, the airflow in the longitudinal direction becomes smoother.

On the other hand, as illustrated in FIG. 10F, the through holes 801c-1 (first through holes, first shapes) may be arranged not to overlap the through holes 801c-2 (second through holes, second shapes) when viewed in the longitudinal direction. In this case, it becomes easier to discharge the water vapor without leakage from the small space partitioned by the conveyance-direction ribs 801-1 and 801-2.

The shape of the through hole may, for example, be circular, elliptical, or quadrilateral (including parallelograms and rounded rectangles). The number of through holes may be one or a plurality.

### Example 2

Example 2 in this disclosure will be described below. This Example differs from Example 1 in that a groove portion is disposed in the longitudinal-direction rib 803 (FIGS. 4 and 5) serving as an intersecting rib. Hereinafter, elements denoted by reference characters in common with Example 1 are regarded, unless specifically stated otherwise, as including substantially the same configuration and function as those described in Example 1, and the following description will primarily address aspects that differ from Example 1.

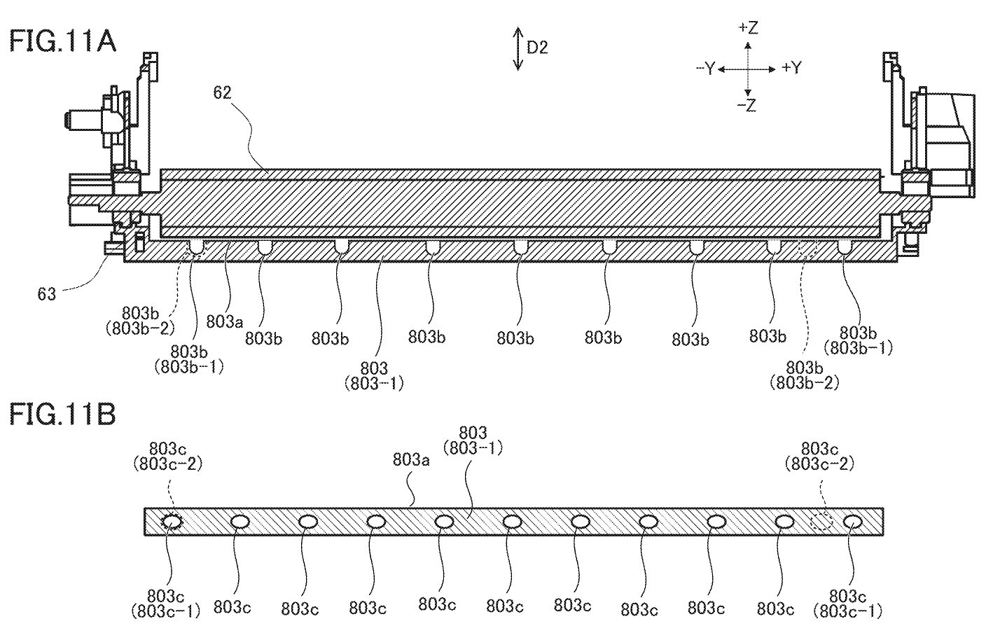

FIG. 11A is a cross-sectional view illustrating a cross-section in the longitudinal direction (cross-section taken along an imaginary plane passing through one of the longitudinal-direction ribs 803) of a lower frame 63 with the pressure roller 62 mounted. In the intersecting direction D2, the longitudinal-direction ribs 803 project from the base surface 630d toward a direction approaching the outer peripheral surface of the pressure roller 62 (i.e., toward an upper side), and each extend in the longitudinal direction (Y direction). In addition, a tip portion 803a (ridge portion) of the longitudinal-direction rib 803 is, for example, formed linearly along the outer peripheral surface of the pressure roller 62.

The lower frame 63 may include the conveyance-direction rib 801 (FIG. 5). In other words, the reinforcement rib 80 may include equal to or more than one conveyance-direction rib 801 and equal to or more than one longitudinal-direction rib 803. To be noted, in this Example, the reinforcement rib 80 may be constituted solely by the longitudinal-direction rib 803 without including the conveyance-direction rib 801.

The lower frame 63 of this Example includes two longitudinal-direction ribs 803 (also refer to FIG. 4). Each longitudinal-direction rib 803 extends in the longitudinal direction while intersecting with a plurality of conveyance-direction ribs 801. A first longitudinal-direction rib 803-1 is an example of a first intersecting rib that extends in the longitudinal direction so as to connect the conveyance-direction ribs 801-1 (first rib) and 801-2 (second rib). A second longitudinal-direction rib 803-2 is an example of a second intersecting rib that extends in the longitudinal direction so as to connect the conveyance-direction ribs 801-1 (first rib) and 801-2 (second rib) and is disposed to face the first intersecting rib in the sheet conveyance direction D1. In addition, the longitudinal-direction ribs 803-1 and 803-2 include the first and second intersecting ribs, serving as portions that extend in the longitudinal direction (Y direction) and the intersecting direction D2 and are disposed between the conveyance-direction ribs 801-1 (first rib) and 801-2 (second rib) in the longitudinal direction.

An end portion on one side of the base surface 630d is referred to as a first end portion 630d3, and an end portion on the other side is referred to as a second end portion 630d4 (FIG. 4). In the sheet conveyance direction, the first intersecting rib (longitudinal-direction rib 803-1) is closer to the first end portion 630d3 than the second end portion 630d4. The second intersecting rib (longitudinal-direction rib 803-2) is closer to the second end portion 630d4 than the first end portion 630d3. In other words, the first and second intersecting ribs may be arranged on the sides opposite to each other with the center in the sheet conveyance direction D1 of the base surface 630d interposed between them.

To be noted, the number of longitudinal-direction ribs 803 may be one or equal to or more than three.

### Groove Portion of Reinforcement Rib

A groove portion 803b is disposed in at least one longitudinal-direction rib 803. The groove portion 803b is a groove-shape (recessed portion, notched portion) in which a part of the tip portion 803a is recessed.

The groove portion 803b (FIG. 11A) disposed in the longitudinal-direction rib 803-1 (first intersecting rib) is an example of a first groove portion, and the groove portion 803b disposed in the longitudinal-direction rib 803-2 (second intersecting rib) is an example of a second groove portion. In addition, the groove portion 803b disposed in the longitudinal-direction rib 803-1 (first intersecting rib) is an example of a first shape, and the groove portion 803b disposed in the longitudinal-direction rib 803-2 (second intersecting rib) is an example of a second shape.

The groove portion 803b establishes communication between small space that is formed between the outer peripheral surface of the pressure roller 62 and the base surface 630d of the lower frame 63 and is partitioned by the longitudinal-direction ribs 803. In other words, the groove portion 803b forms a path that allows the air containing the water vapor to move in the rotational direction of the pressure roller 62. The groove portion 803b allows the air to move from the upstream side toward the downstream side (or in the opposite direction) in the sheet conveyance direction D1.

The airflow through the groove portion 803b is generated, for example, in association with the rotation of the pressure roller 62. The airflow through the groove portion 803b is also generated by the sheet S that passes through the nip portion np1. In addition, it is acceptable to actively generate the airflow through the groove portion 803b by, for example, blower fans mounted in the apparatus body 2.

### Effects of Groove Portion

By disposing the groove portion 803b at the tip portion 803a of the longitudinal-direction rib 803 as in this Example, the stagnation of the air containing the water vapor between the lower frame 63 and the pressure roller 62 can be suppressed. Then, it is possible to suppress the occurrence of the condensation on the pressure roller 62 even in environments such as the high-temperature, high-humidity environment where the sheet S contains a large amount of moisture. In other words, by the airflow passing through the groove portion 803b, the water vapor generated from the sheet S during the image fixation can be expelled from an area adjacent to the outer peripheral surface of the pressure roller 62.

Similarly to the groove portion 801b of the conveyance-direction rib 801, in a case of disposing the groove portions 803b in each of the longitudinal-direction ribs 803 which are adjacent to each other in the sheet conveyance direction D1, positions of the groove portions 803b in the longitudinal direction may overlap. That is, as illustrated at the left end of FIG. 11A, the groove portion 803b-1 (first shape) of the first longitudinal-direction rib 803-1 (first intersecting rib) and the groove portion 803b-2 (second shape) of the second longitudinal-direction rib 803-2 (second intersecting rib) may overlap when viewed in the sheet conveyance direction D1. In this case, the airflow in the rotational direction of the pressure roller 62 becomes smoother, and, thereby, an amount of the air passing through the space between the outer peripheral surface of the pressure roller 62 and the lower frame 63 can be increased.

In contrast to this, in the case of disposing the groove portions 803b in each of the longitudinal-direction ribs 803 which are adjacent to each other in the sheet conveyance direction D1, positions of the groove portions 803b in the longitudinal direction may be arranged so as not to overlap. That is, as illustrated at the right end of FIG. 11A, the groove portion 803b-1 of the first longitudinal-direction rib 803-1 and the groove portion 803b-2 of the second longitudinal-direction rib 803-2 may be configured to be not overlapping when viewed in the sheet conveyance direction D1. By arranging the groove portions 803b of the longitudinal-direction ribs 803, which are adjacent to each other, so as not to overlap each other as described above, it becomes possible to uniformly discharge the water vapor from the small space between the longitudinal-direction ribs 803 which are adjacent to each other.

To be noted, while FIG. 11A illustrates the groove portion 803b having a substantially semicircle shape, the shape of the groove portion 803b is not limited to this, and, for example, rectangular or triangular shapes are acceptable. In addition, FIG. 11A illustrates an example in which a plurality of groove portions 803b are disposed in one longitudinal-direction rib 803 at substantially equal intervals in the longitudinal direction (Y direction); however, for example, only one groove portion 803b may be disposed at the center portion of the longitudinal-direction rib 803. In a case where a plurality of longitudinal-direction ribs 803 are disposed, the groove portions 803b may be formed only in certain of the longitudinal-direction ribs 803.

### Modification Examples

In this Example, an example is described that suppresses the stagnation of the water vapor by disposing the groove portion 803b in the longitudinal-direction rib 803; however, as illustrated in FIG. 11B, instead of the groove portions 803b, it is acceptable to form through holes in the longitudinal-direction rib 803. In other words, holes penetrating in the rotational direction of the pressure roller 62 may be formed at portions closer to the root side (base surface 630d side) than the tip portion 803a of the longitudinal-direction rib 803. By forming the through holes 803c in the longitudinal-direction rib 803, the air transfer between the small space partitioned by the longitudinal-direction ribs 803 is facilitated, and, thereby, it is possible to assist in the discharge of the water vapor.

FIG. 11B is a diagram illustrating an example of the first longitudinal-direction rib 803-1 in which the through holes 803c (first through holes) are formed. Similar through holes 803c (second through holes) may be formed in the second longitudinal-direction rib 803-2 (second intersecting rib). As illustrated at the left end of FIG. 11B, the through hole 803c-1 (first through hole) of the first longitudinal-direction rib 803-1 (first intersecting rib) and the through hole 803c-2 (second through hole) of the second longitudinal-direction rib 803-2 (second intersecting rib) may overlap when viewed in the sheet conveyance direction D1. In this case, the airflow in the sheet conveyance direction D1 becomes smoother. In contrast, as illustrated at the right end of FIG. 11B, the through hole 803c-1 of the first longitudinal-direction rib 803-1 and the through hole 803c-2 of the second longitudinal-direction rib 803-2 may be configured to be a non-overlapping positional relationship when viewed in the sheet conveyance direction D1. In this case, it becomes possible to uniformly discharge the water vapor from the small space between the longitudinal-direction ribs 803-1 and 803-2.

In addition, in this Example, an example is described in which a plurality of groove portions 803b having substantially equal size and shape are arranged side by side at substantially equal intervals. It is not limited to this; the plurality of groove portions or through holes may differ from each other in size and shape, and the arrangement of the plurality of groove portions or through holes in the longitudinal direction (Y direction) is not required to be at equal intervals. For example, in a case where the central region in the longitudinal direction is more susceptible to the occurrence of the condensation on the pressure roller 62 than peripheral regions including the end portions of the roller portion 62b of the pressure roller 62, spacing between adjacent groove portions in the central region may be set narrower than spacing between adjacent groove portions in regions at both end portions. In addition, in a similar case, the size of the groove portions disposed in the central region may be enlarged with respect to the size of the groove portions in the regions at both the end portions.

In addition, while the groove portion 803b may be disposed in at least one of the plurality of longitudinal-direction ribs 803, the groove portion 803b may be disposed in each of the plurality of longitudinal-direction ribs 803. In this case, by aligning the arrangement of the groove portions 803b among the plurality of longitudinal-direction ribs in the longitudinal direction, it is possible to facilitate smoother airflow in the rotational axis direction of the pressure roller 62. On the other hand, by varying the arrangement of the groove portions 803b among the plurality of longitudinal-direction ribs in the longitudinal direction, it is possible to uniformly discharge the water vapor from the small space partitioned by the longitudinal-direction ribs 803.

### Example 3

Example 3 in this disclosure will be described below. This Example differs from Example 1 in that a recessed portion is disposed at an intersecting portion 802 of the conveyance-direction rib 801 and the longitudinal-direction rib 803. Hereinafter, elements denoted by reference characters in common with Example 1 are regarded, unless specifically stated otherwise, as including substantially the same configuration and function as those described in Example 1, and the following description will primarily address aspects that differ from Example 1.

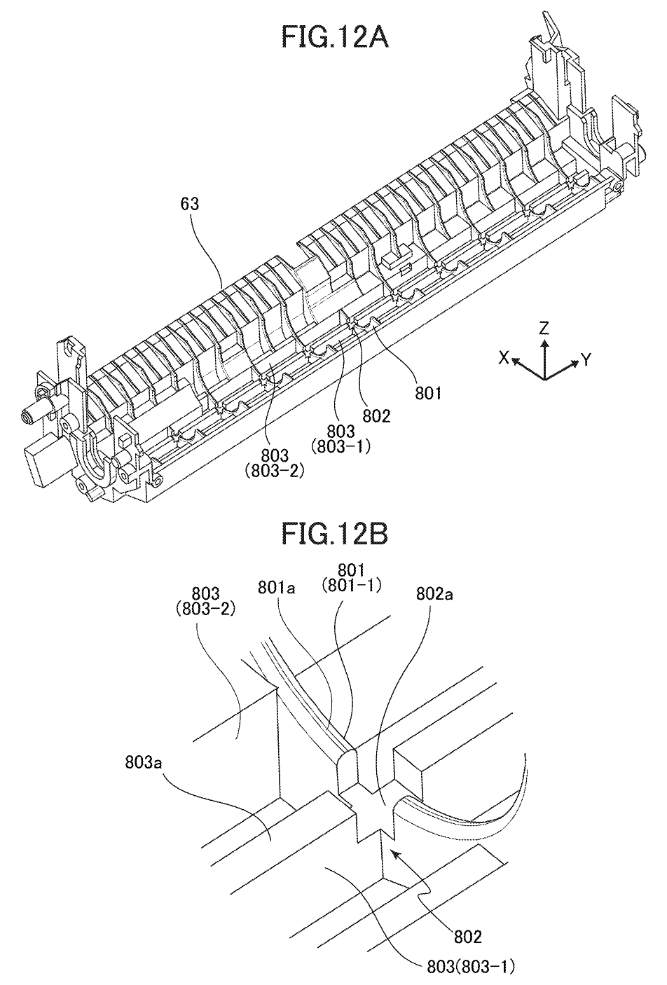

FIG. 12A is a perspective view illustrating a lower frame 63. FIG. 12B is an enlarged view of the intersecting portion 802 at which the conveyance-direction rib 801 (first conveyance-direction rib 801-1) and the longitudinal-direction rib 803 (first longitudinal-direction rib 803-1) intersect.

As illustrated in FIGS. 12A and 12B, in the lower frame 63 of this Example, a recessed portion 802a is disposed at at least one of the intersecting portions 802 at which the conveyance-direction ribs 801 and the longitudinal-direction ribs 803 intersect. The recessed portion 802a is a recessed portion that is recessed toward a side further away from the rotational axis of the pressure roller 62 than the tip portion 801a of the conveyance-direction rib 801, and is also recessed toward a side further away from the rotational axis of the pressure roller 62 than the tip portion 803a of the longitudinal-direction rib 803. In other words, a tip portion (802a) in the intersecting direction D2 of the intersecting portion 802 is further recessed than the tip portion 803a in the intersecting direction D2 of the longitudinal-direction rib 803-1 (first intersecting rib).

It can be said that the recessed portion 802a is a groove portion in which a part of the tip portion 801a of the conveyance-direction rib 801 is recessed. In addition, it can be said that the recessed portion 802a is a groove portion in which a part of the tip portion 803a of the longitudinal-direction rib 803 is recessed. Therefore, the recessed portion 802a is an example of the first and second groove portions of the first and second ribs described in Example 1, and is also an example of the first and second groove portions of the first and second intersecting ribs described in Example 2.

In this Example, one longitudinal-direction rib 803 intersects a plurality of conveyance-direction ribs 801. Then, the recessed portions 802a are disposed at each of a plurality of intersecting portions 802 at which the one longitudinal-direction rib 803 and the plurality of conveyance-direction ribs 801 intersect.

### Effects of Concave Portion

The recessed portion 802a of this Example provides the same function as each of the groove portion 801b of the conveyance-direction rib 801 described in Example 1, and the groove portion 803b of the longitudinal-direction rib 803. That is, by disposing the recessed portions 802a, small spaces partitioned by the longitudinal-direction rib 803 and the conveyance-direction ribs 801 communicate with each other, and, due to airflow passing through the recessed portions 802a, it is possible to facilitate the discharge of the water vapor.

In addition, since the intersecting portions 802, at which the longitudinal-direction rib 803 and the conveyance-direction ribs 801 intersect, have inherently relatively high stiffness, it is possible to suppress reduction in the stiffness of the lower frame 63 due to the disposition of the recessed portions 802a. Therefore, it is possible to suppress the deflection of the lower frame 63 caused by the application of pressure to the nip portion np1, as well as the occurrence of creep deformation from extended operational duration. In addition, for example, since it is easier to ensure the stiffness of the lower frame 63, which is a molded member, without increasing the wall thickness of the lower frame 63, there is an advantage in that it becomes possible to reduce the weight of the fixing unit 6 (and the entire image forming apparatus 1) and to decrease the consumption of resin raw materials.

### Modification Examples

While, in Example 3, the recessed portions 802a are disposed at all the plurality of intersecting portions 802 at which the one longitudinal-direction rib 803 and the plurality of the conveyance-direction ribs 801 intersect, the recessed portions 802a may be disposed only at certain of the intersecting portions 802. In addition, the shape of the recessed portion 802a is not limited to that illustrated in FIG. 12B.

### Example 4

Example 4 in this disclosure will be described below. This Example differs from Example 1 in that a through hole 630h is disposed in portions of a lower frame 63 other than the reinforcement rib 80. Hereinafter, elements denoted by reference characters in common with Example 1 are regarded, unless specifically stated otherwise, as including substantially the same configuration and function as those described in Example 1, and the following description will primarily address aspects that differ from Example 1.

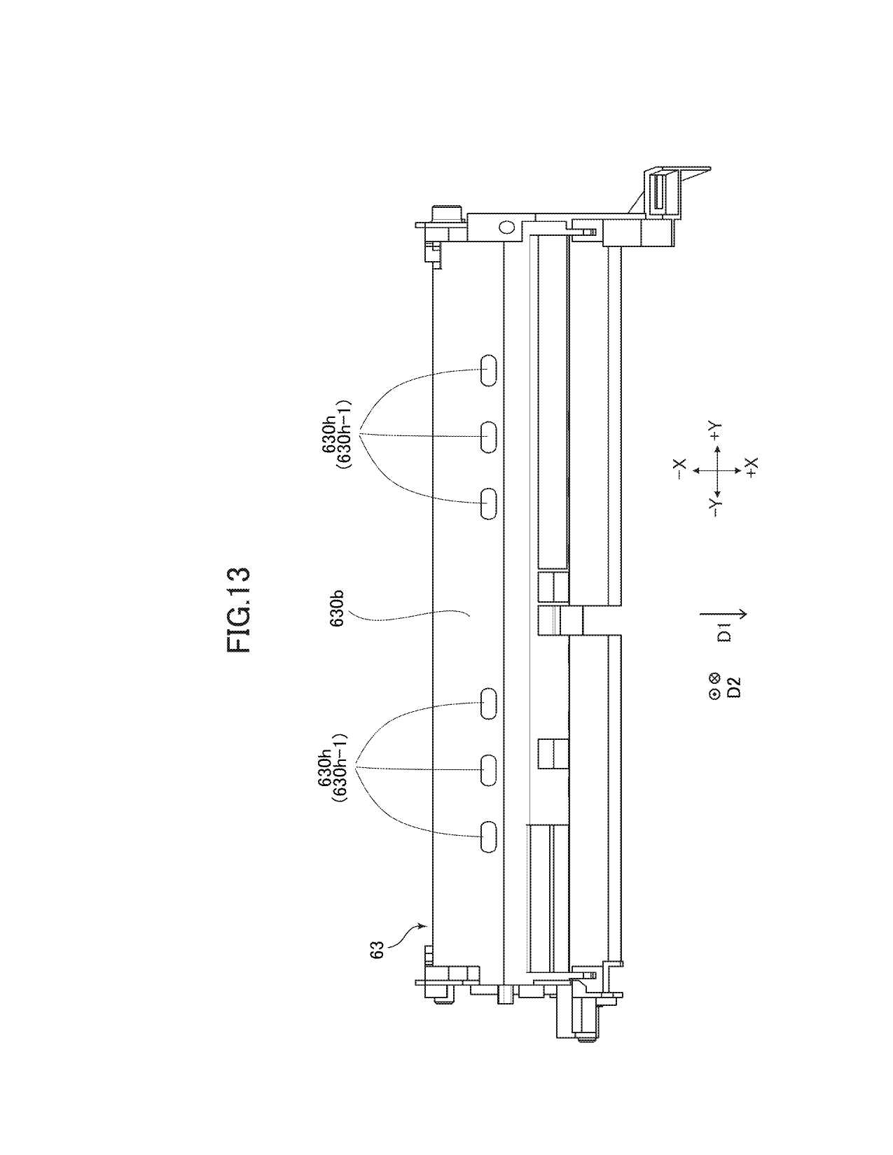

FIG. 13 is a bottom view illustrating a lower frame 63 when viewed from below. In more particular, FIG. 13 illustrates the lower frame 63 of this Example as viewed from a viewpoint from below to above in FIG. 4 toward a direction perpendicular to both the longitudinal direction (Y direction) and the sheet conveyance direction D1.

In the lower frame 63 of this Example, a plurality of through holes 630h are formed. Each through hole 630h is formed at a position of the base surface 630d that does not include the reinforcement rib 80 (conveyance and longitudinal-direction ribs 801 and 803). Any one of the plurality of the through holes 630h can be referred to as a first hole or a first through hole, and another one of the plurality of the through holes 630h can be referred to as a second hole or a second through hole. In this case, the first and second holes (first and second through holes) are aligned in the longitudinal direction.

In the lower frame 63 of this Example, as an example of the through hole 630h, a lower through hole 630h-1 that penetrates from the base surface 630d to the bottom surface 630b is formed. The lower through hole 630h-1 penetrates the base surface 630d from above to below. In addition, in the illustrated example, six lower through holes 630h-1 are arranged in the longitudinal direction at spaced intervals from each other.

Through the lower through holes 630h-1, communication is established between an internal space of the lower frame 63 (space between the bottom surface 630b and the outer peripheral surface of the pressure roller 62) and an external space of the lower frame 63. In other words, the lower through holes 630h-1 form pathways that allow the water vapor to escape from the internal space of the lower frame 63 to the external space.

### Effects of Through Hole

By disposing the through hole (ventilation hole) in the lower frame 63 as this Example, it is possible to suppress the stagnation of the water vapor between the lower frame 63 and the pressure roller 62. Then, it is possible to suppress the occurrence of the condensation on the pressure roller 62 even in environments such as the high-temperature, high-humidity environment in which the sheet S contains a large amount of water.

In addition, in this Example, it is not necessarily required to dispose a through hole and a grove portion in the reinforcement rib 80. Therefore, it is possible to suppress the occurrence of the condensation on the pressure roller 62 while restricting the impact on the stiffness of the lower frame 63.

### Modification Examples

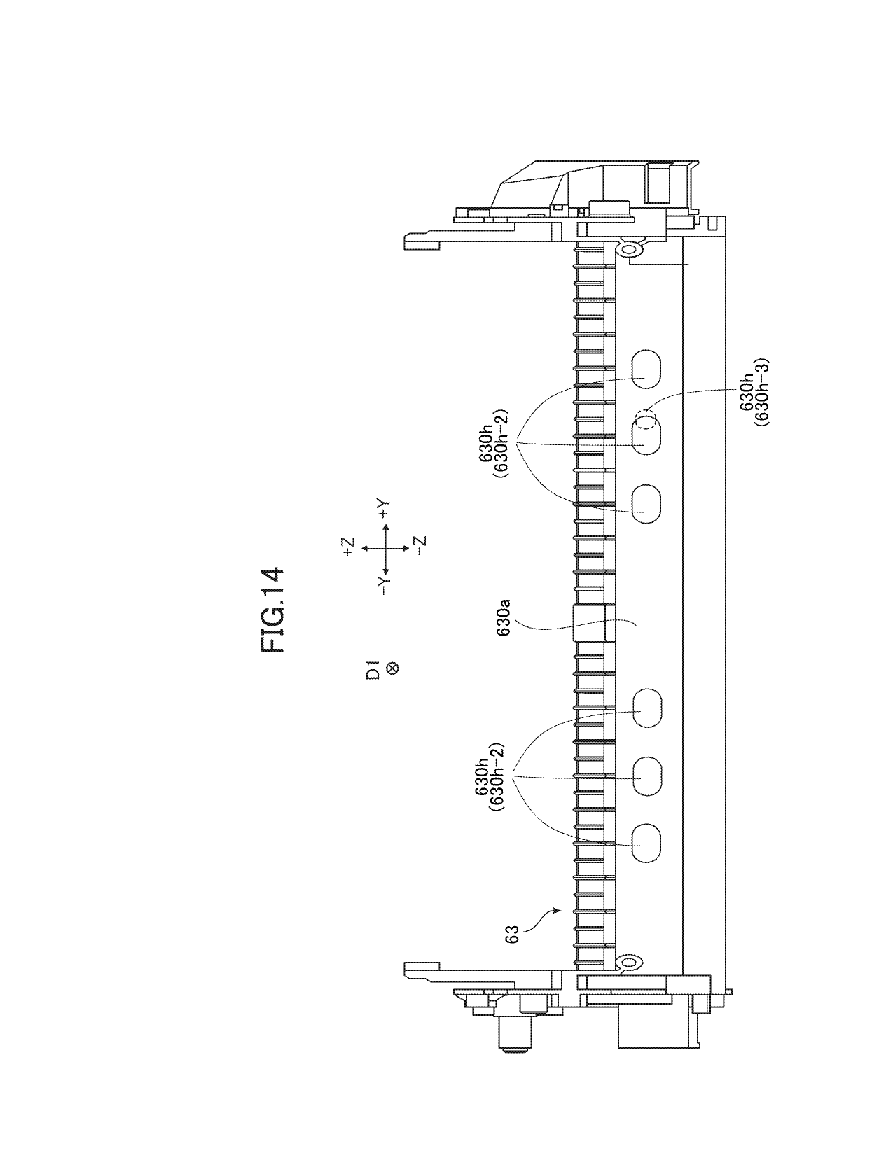

While, in Example 4, the lower through hole 630h-1 is formed in the bottom surface 630b of the lower frame 63, the through hole may be formed in other portions of the lower frame 63. FIG. 14 is a diagram illustrating a lower frame 63 according to one modification example (Modification Example 1) as viewed from the upstream side in the sheet conveyance direction D1. In Modification Example 1, as the through hole 630h, a plurality of front through holes 630h-2 that penetrate from the base surface 630d to the front surface 630a of the lower frame 63 are formed. The front through holes 630h-2 penetrate from the base surface 630d to the exterior of the lower frame 63 toward a direction opposite to the sheet conveyance direction D1.

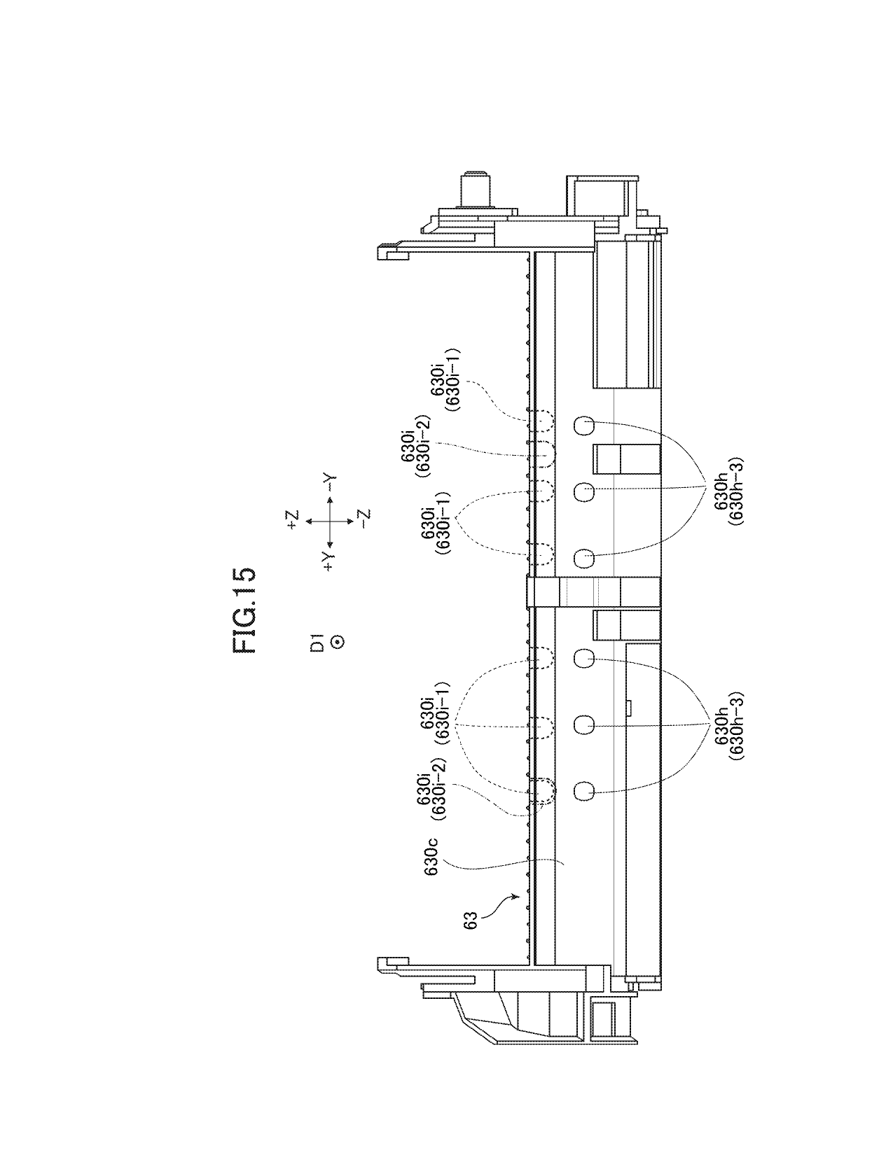

FIG. 15 is a diagram illustrating a lower frame 63 according to the other modification example (Modification Example 2) as viewed from the downstream side in the sheet conveyance direction D1. In Modification Example 2, as the through hole 630h, a plurality of rear through holes 630h-3 that penetrate from the base surface 630d to the rear surface 630c of the lower frame 63 are formed. The rear through holes 630h-3 penetrate from the base surface 630d to the exterior of the lower frame 63 toward the sheet conveyance direction D1.

One of the rear through holes 630h-3 can be referred to as a first hole or a first through hole, and one of the front through holes 630h-2 can be referred to as a second hole or a second through hole. For example, as illustrated in FIG. 14 in which the rear through holes 630h-3 are indicated by the dashed lines, when viewed in the sheet conveyance direction D1, the rear through holes 630h-3 (first holes, first through holes) may overlap the front through holes 630h-2 (second holes, second through holes). In other words, positions in the longitudinal direction of the through holes 630h, which open to the front surface 630a of the lower frame 63, and positions in the longitudinal direction of the through holes 630h, which open to the rear surface 630c of the lower frame 63, may be aligned. Thereby, it is possible to enable the air to flow more smoothly along the outer peripheral surface of the pressure roller 62.

On the other hand, when viewed in the sheet conveyance direction D1, the rear through holes 630h-3 (first holes, first through holes) and the front through holes 630h-2 (second holes, a second through holes) may have a non-overlapping positional relationship. In other words, the positions in the longitudinal direction of the through holes 630h, which open to the front surface 630a of the lower frame 63, and the positions in the longitudinal direction of the through holes 630h, which open to the rear surface 630c of the lower frame 63, may be different from each other. Thereby, it becomes easier to uniformly expel the water vapor from the space between the lower frame 63 and the outer peripheral surface of the pressure roller 62.

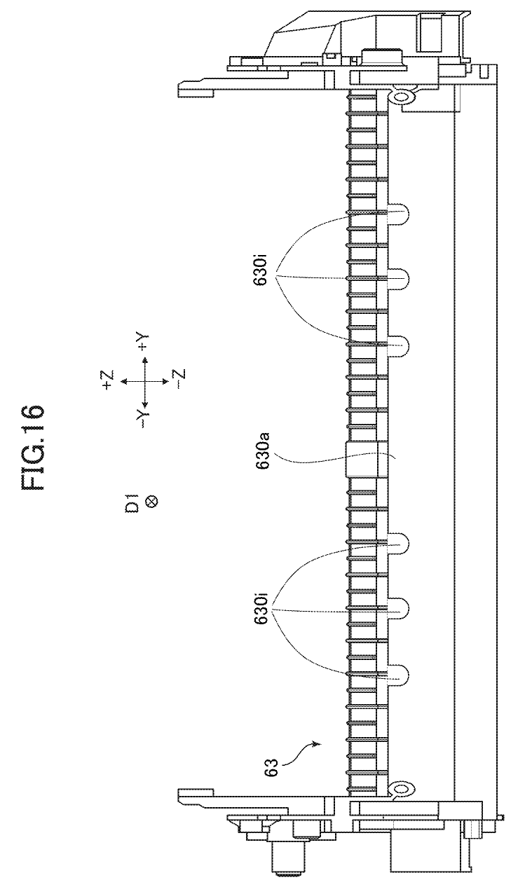

FIG. 16 is a diagram illustrating a lower frame 63 according to another modification example (Modification Example 3) as viewed from the upstream side in the sheet conveyance direction D1. In Modification Example 3, instead of forming the through hole 630h in the lower frame 63, a groove portion 630i that penetrates from the base surface 630d of the lower frame 63 to the exterior is formed in an edge portion of the lower frame 63. In an example illustrated in FIG. 16, equal to or more than one groove portion 630i penetrating from the base surface 630d of the lower frame 63 to the front surface 630a is formed. The groove portion 630i is a recessed shape in which a part of an upper edge of the front surface 630a is recessed downward. The groove portion 630i penetrates from the base surface 630d to the exterior of the lower frame 63 toward the direction opposite to the sheet conveyance direction D1. While, in the illustrated example, the six groove portions 630i are arranged side by side in the longitudinal direction, the number of groove portions 630i can be varied. One of the six groove portions 630i can be referred to as a first groove, and another one of the six groove portions 630i can be referred to as a second groove.

As illustrated by the dashed lines in FIG. 15, the groove portions 630i may be formed in the rear surface 630c of the lower frame 63. This groove portion 630i is a recessed shape in which a part of an upper edge of the rear surface 630c is recessed downward, and is formed to penetrate from the base surface 630d of the lower frame 63 to the rear surface 630c. In other words, this groove portion 630i penetrates from the base surface 630d to the exterior of the lower frame 63 toward the sheet conveyance direction D1.

When a groove portion 630i-1 of the rear surface 630c is referred to as the first groove, a groove portion 630i-2 of the front surface 630a can be referred to as the second groove. As the groove portion 630i-2 illustrated singularly on the left side of FIG. 15, the groove portion 630i-1 of the rear surface 630c and the groove portion 630i-2 of the front surface 630a may overlap when viewed in the sheet conveyance direction D1. In addition, as the groove portion 630i-2 illustrated singularly on the right side of FIG. 15, the groove portion 630i-1 of the rear surface 630c and the groove portion 630i-2 of the front surface 630a may be arranged to be non-overlapping when viewed in the sheet conveyance direction D1.

Even in each of Modification Examples described above, by disposing the through hole or the groove portion in the lower frame 63, it is possible to suppress the stagnation of the air containing the water vapor between the lower frame 63 and the pressure roller 62. Then, it is possible to suppress the occurrence of the condensation on the pressure roller 62 even in environments such as the high-temperature, high-humidity environment in which the sheet S contains a large amount of water. In addition, by disposing the through hole or the groove portion in the front surface 630a or the rear surface 630c, there is an advantage that it becomes easier to expel the water vapor by the airflow generated by the sheet S when the sheet S passes through the fixing unit 6.

The number, arrangement, shape, and the like of through holes or groove portions formed in the lower frame 63 are not limited to those illustrated in FIGS. 13 to 16, and, for example, rectangular through holes or groove portions may be adopted. In addition, it is acceptable to combine the through hole and the groove portion that are described in Example 4 and Modification Examples 1 to 3. For example, it is acceptable to form the through holes in each of the front surface 630a and the rear surface 630c of the lower frame 63.

### Example 5

Example 5 in this disclosure will be described below. While the through hole or the groove portion that has the function of expelling the water vapor generated from the sheet S is described in Examples 1 to 4, this Example differs from Examples 1 to 4 in that a through hole and a groove portion for mounting a sensor (temperature detection unit) relating to the fixing unit 6 are disposed. Hereinafter, elements denoted by reference characters in common with Example 1 are regarded, unless specifically stated otherwise, as including substantially the same configuration and function as those described in Example 1, and the following description will primarily address aspects that differ from Example 1.

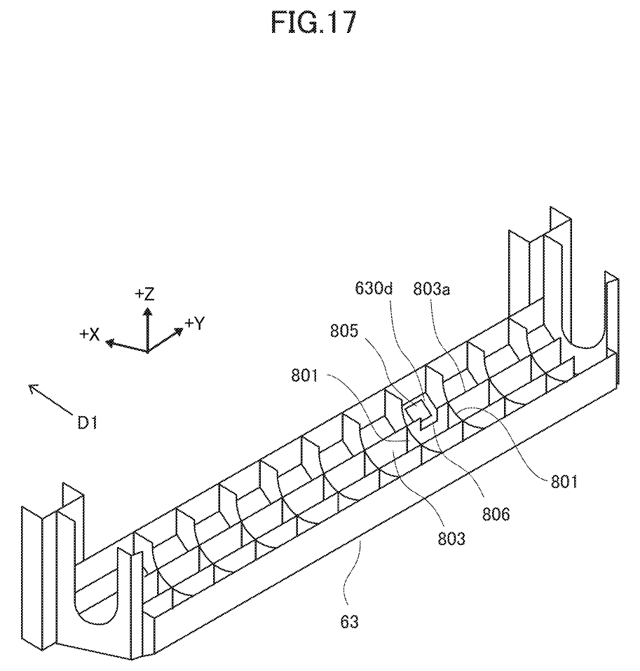

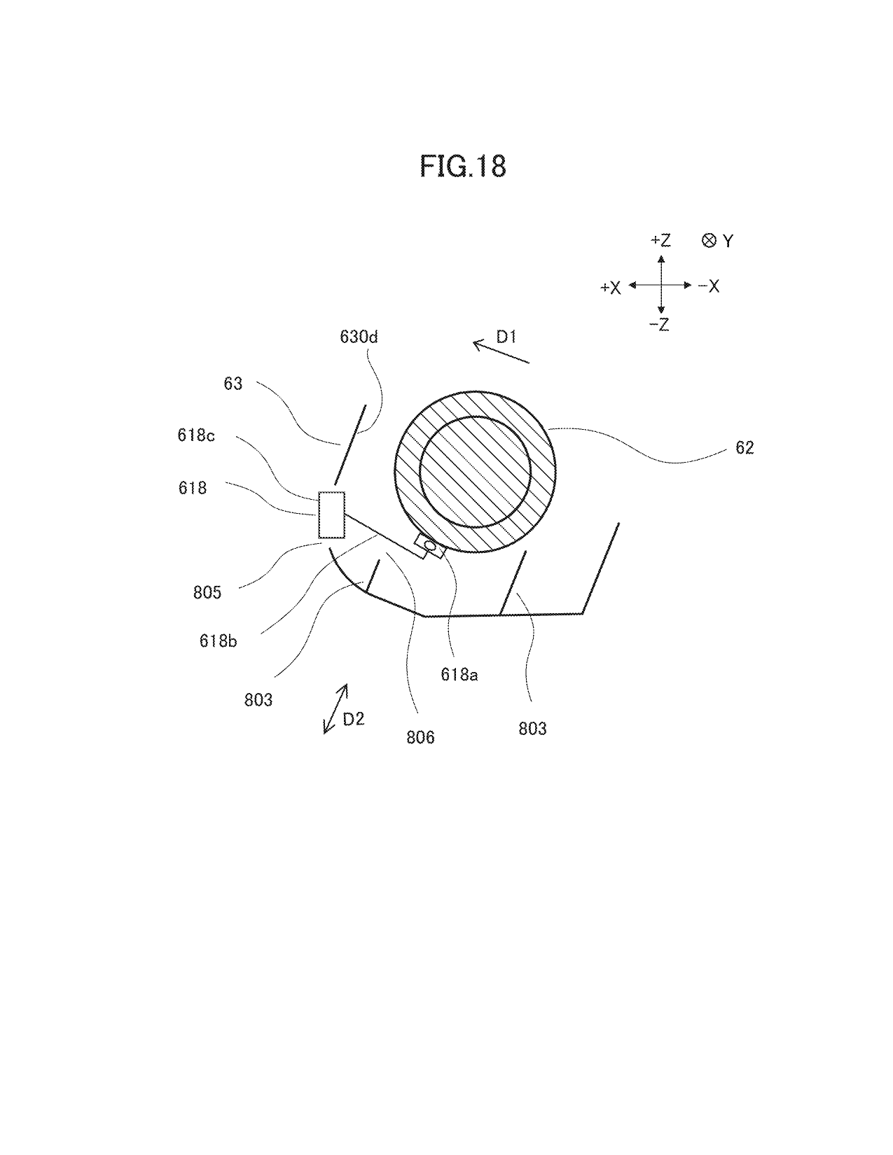

In this Example, as an example of the temperature detection unit, a thermistor 618 that is disposed to face the pressure roller 62 is used. FIG. 17 is a perspective view schematically illustrating a lower frame 63 according to this Example. FIG. 18 is a cross-sectional view taken along an imaginary plane perpendicular to the longitudinal direction (Y direction), illustrating the lower frame 63, the pressure roller 62, and the thermistor 618.

As illustrated in FIGS. 17 and 18, a fixing unit 6 of this Example includes a contact type thermistor 618. The thermistor 618 is arranged inside the lower frame 63 so as to come into contact with the outer peripheral surface of the pressure roller 62 (FIG. 18), and outputs a signal (for example, voltage) corresponding to the temperature of the pressure roller 62. The thermistor 618 may, for example, be a thin-film thermistor.

A control unit of the image forming apparatus 1 acquires the temperature information of the pressure roller 62 based on the signal from the thermistor 618, and controls the temperature of the pressure roller 62 by controlling the heat generation of the heater 611 (FIG. 3) of the fixing unit 6. By appropriately controlling the temperature of the pressure roller 62, it is possible to achieve the increased productivity, enhanced fixability, and improved image quality of the image forming apparatus 1.

To be noted, the thermistor 618 is an example of the temperature detection unit, and it is acceptable to employ a temperature detection unit including other thermal sensing elements such as thermocouples or platinum resistance temperature detectors. In addition, as in a modification example described below, it is also acceptable to employ a non-contact type temperature detection unit (non-contact sensor).

As illustrated in FIGS. 17 and 18, a through hole 805 (sensor mounting hole) and a groove portion 806 are formed in the lower frame 63 of this Example for arranging the thermistor 618. The through hole 805 penetrates from the base surface 630d of the lower frame 63 to the exterior of the lower frame 63. While the through hole 805 opens to the rear surface 630c in the illustrated example, the through hole 805 may open to the front surface 630a or the bottom surface 630b.

The groove portion 806 is a groove shape (recessed portion, notched portion) which is formed in the reinforcement rib 80 of the lower frame 63. The groove portion 806 of this Example is formed in the longitudinal-direction rib 803. The groove portion 806 is a recessed shape in which a part of the tip portion 803a of the longitudinal-direction rib 803 (intersecting rib), extending in the longitudinal direction so as to connect the conveyance-direction ribs 801 (first and second ribs) which are positioned adjacent to each other in the longitudinal direction, is recessed. When viewed in a direction in which the longitudinal-direction rib 803 extends toward the lower frame 63 (intersecting direction D2), the thermistor 618 (temperature detection unit) includes a portion that overlaps the groove portion 806.

The thermistor 618 is arranged so as to penetrate the through hole 805 and face the outer peripheral surface of the pressure roller 62. The thermistor 618 includes a head portion 618a, which comes into contact with the outer peripheral surface of the pressure roller 62, a base portion 618c, which is supported by the lower frame 63, and a connecting portion 618b, which connects the head portion 618a and the base portion 618c. The head portion 618a includes, for example, a thermosensitive element, such as a negative temperature coefficient (NTC) type semiconductor element, whose resistance value changes in response to temperature. The base portion 618c includes a connector that is coupled to wiring used for electrically connecting with the control unit of the image forming apparatus 1. The connecting portion 618b includes a conductor for electrically connecting the base portion 618c and the thermosensitive element of the head portion 618a, and supports the head portion 618a.

By forming the through hole 805 in the lower frame 63, it is possible to arrange the thermistor 618 to face the outer peripheral surface of the pressure roller 62. In addition, through the through hole 805, it is possible to connect the thermistor 618 to wiring, which is routed along the exterior of the lower frame 63.

In addition, by forming the groove portions 806 in the reinforcement rib 80 (longitudinal-direction rib 803) of the lower frame 63, it is possible to easily achieve an arrangement in which the head portion 618a comes into contact with the outer peripheral surface of the pressure roller 62. If the groove portion 806 is not disposed, there may be insufficient space for the arrangement of the thermistor 618, and mounting of the thermistor 618 may become difficult; therefore, sometimes, reduction in workability during assembly may be caused, and defects such as excessive contact between the head portion 618a and the pressure roller 62 may occur.

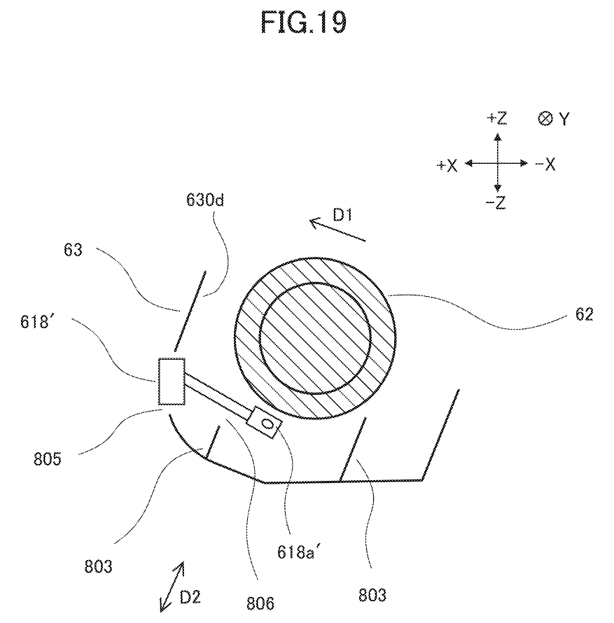

While, in FIG. 18, the contact type thermistor 618 is illustrated as an example, as illustrated in FIG. 19, a non-contact type thermistor 618’, serving as a non-contact type temperature detection unit, may be employed. The non-contact type thermistor 618’ is arranged such that a head portion 618a’ does not come into contact with the outer peripheral surface of the pressure roller 62. The non-contact type thermistor 618’ outputs a signal corresponding to the temperature of the pressure roller 62 by detecting thermal radiation (infrared rays) from the pressure roller 62. Even in this case, by forming the through hole 805 in the lower frame 63 and forming the groove portion 806 in the reinforcement rib 80, it is possible to arrange the non-contact type thermistor 618’.

To be noted, the non-contact type thermistor 618’ is an example of the non-contact type temperature detection unit, and a non-contact type temperature detection unit employing other detection methods may be utilized.

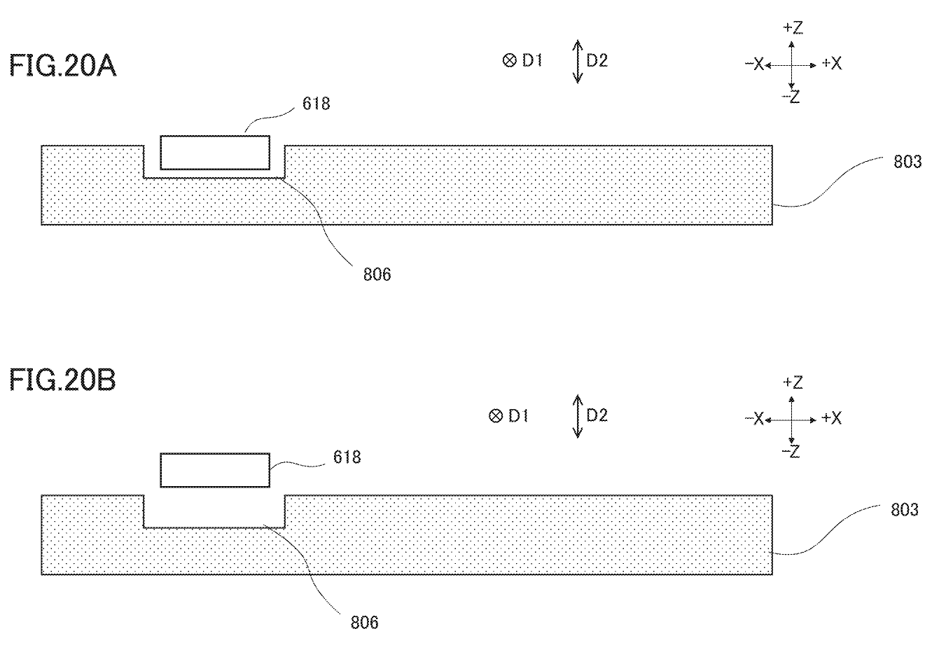

FIG. 20A is a cross-sectional view schematically illustrating a positional relationship between the longitudinal-direction rib 803 and the thermistor 618 in a plane that is perpendicular to the sheet conveyance direction D1 and includes the longitudinal-direction rib 803. In the cross-section illustrated in FIG. 20A, at least part of the thermistor 618 (temperature detection unit) is positioned inside the groove portion 806. In other words, when viewed in the sheet conveyance direction D1, at least part of the thermistor 618 extends further inward into the groove portion 806 as compared to the tip portion 803a (ridge portion) of the longitudinal-direction rib 803. In particular, when viewed in the intersecting direction D2, the overlapping portion of the thermistor 618 with the groove portion 806 is positioned inside the groove portion 806. With this configuration, it is possible to more easily position the thermistor 618.

In addition, it can be said that FIG. 20A illustrates a view taken in a tangential direction of the outer peripheral surface of the pressure roller 62 at a position facing the head portion 618a of the thermistor 618. Therefore, in this example, when viewed in the tangential direction of the outer peripheral surface of the pressure roller 62, at least part of the thermistor 618 is positioned on a farther side (the lower side in FIG. 20A) from the pressure roller 62 than the tip portion 803a of the longitudinal-direction rib 803.

FIG. 20B is a cross-sectional view schematically illustrating another positional relationship between the longitudinal-direction rib 803 and the thermistor 618. In the cross-section illustrated in FIG. 20B, the entire thermistor 618 is positioned outside the groove portion 806. In other words, when viewed in the sheet conveyance direction D1, the entire thermistor 618 is positioned on a side (the upper side in FIG. 20B) closer to the pressure roller 62 than the tip portion 803a (ridge portion) of the longitudinal-direction rib 803.

In the case of the example illustrated in FIG. 20B, by disposing the groove portion 806 of the longitudinal-direction rib 803, it is possible to avoid interference between the thermistor 618 and the longitudinal-direction rib 803 resulting from dimensional tolerances of components or assembly tolerances of the thermistor 618 or the lower frame 63. Therefore, even in the case of the example illustrated in FIG. 20B, it is possible to more easily arrange the thermistor 618 used for detecting the temperature of the pressure roller 62.

### Modification Examples

In Example 5, the thermistor 618 for detecting the temperature of the pressure roller 62 is disposed at only one location; however, it is not limited to this, and the thermistor 618 may be disposed at a plurality of locations. For example, sometimes, an additional thermistor is disposed to detect temperature at an end portion in the longitudinal direction of the pressure roller 62. In this case, the control unit of the image forming apparatus 1 can monitor the temperature at the end portion of the pressure roller 62.

Here, when image formation is performed on a recording material whose width in the longitudinal direction is shorter than a heat generation region of the heater 611, a phenomenon of a temperature rise in the pressure roller 62 (and the belt 614) within regions in the longitudinal direction through which the recording material does not pass is referred to as a non-sheet passing region temperature rise. The non-sheet passing region temperature rise may cause the damage or deterioration of members due to high temperature, and may result in image defects when the image formation is subsequently performed on a recording material having increased width. If the additional thermistor is not employed, when forming images on the recoding material of narrow width, it may be considered to prevent the detrimental effects of the non-sheet passing region temperature rise by reducing throughput. On the other hand, by monitoring the temperature at the end portion of the pressure roller 62 using the additional thermistor, it becomes possible to execute the image formation at high throughput while avoiding the detrimental effects of the non-sheet passing region temperature rise. Therefore, by disposing the additional thermistor at the end portion of the pressure roller 62, it is possible to enhance the productivity of the image forming apparatus 1.

In the case of arranging a plurality of temperature detection units as described above, it is acceptable to form the through holes 805 and the groove portions 806 in the lower frame 63 corresponding to each of the plurality of temperature detection units. Thereby, it is possible to easily arrange the contact type temperature detection units that come into contact with the outer peripheral surface of the pressure roller 62, or the non-contact type temperature detection units that are positioned at locations adjacent to the pressure roller 62.

According to the technology of this disclosure, it is possible to provide a new configuration of the fixing unit that advances conventional technology.

### Supplement to This Disclosure

This disclosure includes at least the following configurations and/or methods.

### Configuration 1

A fixing unit configured to fix an image on a recording material, the fixing unit including:

an endless belt;

a heater configured to heat an inner surface of the belt;

a pressure roller including a roller portion formed of rubber and configured to form a nip portion by sandwiching the belt with the heater such that the recording material is conveyed in a conveyance direction through the nip portion; and

a frame formed of resin, configured to support the pressure roller rotatably, and disposed to face the roller portion over a longitudinal direction of the pressure roller,

wherein the frame includes a base surface that faces an outer peripheral surface of the roller portion over the longitudinal direction,

wherein the base surface includes a first rib and a second rib that extend in an intersecting direction intersecting both the conveyance direction and the longitudinal direction,

wherein, when viewed in the longitudinal direction, a tip portion of the first rib and a tip portion of the second rib each have a circular arc shape along the outer peripheral surface of the roller portion,

wherein the first rib and the second rib are aligned in the longitudinal direction,

wherein the base surface includes a first intersecting rib having a first shape and a second intersecting rib having a second shape,

wherein the first intersecting rib and the second intersecting rib are positioned between the first rib and the second rib in the longitudinal direction, and extend in the longitudinal direction and in the intersecting direction,

wherein the first intersecting rib and the second intersecting rib are disposed at different positions in the conveyance direction,

wherein the first shape is a first through hole that penetrates the first intersecting rib in the conveyance direction, or a groove portion that is formed in a tip portion of the first intersecting rib in the intersecting direction, and

wherein the second shape is a second through hole that penetrates the second intersecting rib in the conveyance direction, or a groove portion that is formed in a tip portion of the second intersecting rib in the intersecting direction.

### Configuration 2

The fixing unit according to Configuration 1,

wherein one side of end portions in the conveyance direction of the base surface is referred to as a first end portion and the other side of the end portions is referred to as a second end portion,

wherein, in the conveyance direction, the first intersecting rib is disposed closer to the first end portion than to the second end portion, and

wherein, in the conveyance direction, the second intersecting rib is disposed closer to the second end portion than to the first end portion.

### Configuration 3

The fixing unit according to Configuration 1 or 2,

wherein the first intersecting rib and the second intersecting rib face each other in the conveyance direction, and

wherein, when viewed in the conveyance direction, the first shape overlaps the second shape.

### Configuration 4

The fixing unit according to Configuration 1 or 2,

wherein the first intersecting rib and the second intersecting rib face each other in the conveyance direction, and

wherein, when viewed in the conveyance direction, the first shape does not overlap the second shape.

### Configuration 5

A fixing unit configured to fix an image on a recording material, the fixing unit including:

an endless belt;

a heater configured to heat an inner surface of the belt;

a pressure roller including a roller portion formed of rubber and configured to form a nip portion by sandwiching the belt with the heater such that the recording material is conveyed in a conveyance direction through the nip portion; and

a frame formed of resin, configured to support the pressure roller rotatably, and disposed to face the roller portion over a longitudinal direction of the pressure roller,

wherein the frame includes a base surface that faces the roller portion over an intersecting direction intersecting both the conveyance direction and the longitudinal direction,

wherein the base surface includes a first rib and a second rib that extend in the intersecting direction,

wherein, when viewed in the longitudinal direction, a tip portion of the first rib and a tip portion of the second rib each have a circular arc shape along an outer peripheral surface of the roller portion,

wherein the first rib and the second rib are aligned in the longitudinal direction,

wherein the frame includes a first through hole and a second through hole, and

wherein the first through hole and the second through hole are formed at positions that do not include the first rib and the second rib of the base surface, and penetrate from the base surface to an exterior of the frame.

### Configuration 6

The fixing unit according to Configuration 5,

wherein, when viewed in the conveyance direction, the first through hole and the second through hole overlap.

### Configuration 7

The fixing unit according to Configuration 5,

wherein, when viewed in the conveyance direction, the first through hole and the second through hole do not overlap.

### Configuration 8

The fixing unit according to Configuration 5,

wherein the first through hole and the second through hole are aligned in the longitudinal direction.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-217047, filed December 11, 2024, which is hereby incorporated by reference herein in its entirety.

What is claimed is:

1. A fixing unit comprising:
an endless belt;
a heater configured to heat an inner surface of the belt;
a pressure roller including a roller portion formed of rubber and configured to form a nip portion by sandwiching the belt with the heater such that a recording material is conveyed in a conveyance direction through the nip portion; and
a frame formed of resin, configured to support the pressure roller rotatably, and disposed to face the roller portion over a longitudinal direction of the pressure roller,
wherein the frame includes a base surface that faces an outer peripheral surface of the roller portion over the longitudinal direction,
wherein the base surface includes a first rib and a second rib that extend in an intersecting direction intersecting both the conveyance direction and the longitudinal direction,
wherein, when viewed in the longitudinal direction, a tip portion of the first rib and a tip portion of the second rib each have a circular arc shape along the outer peripheral surface of the roller portion,
wherein the first rib and the second rib are aligned in the longitudinal direction,
wherein the first rib is formed with a first shape,
wherein the second rib is formed with a second shape,
wherein the first shape is a first through hole that penetrates the first rib in the longitudinal direction, or a first groove portion that is formed in a part of the circular arc shape of the first rib, and
wherein the second shape is a second through hole that penetrates the second rib in the longitudinal direction, or a second groove portion that is formed in a part of the circular arc shape of the second rib.

2. The fixing unit according to claim 1,
wherein, when one side of end portions in the longitudinal direction of the base surface is referred to as a first end portion and another side of the end portions is referred to as a second end portion,
in the longitudinal direction, the first rib is disposed closer to the first end portion than to the second end portion, and,
in the longitudinal direction, the second rib is disposed closer to the second end portion than to the first end portion.

3. The fixing unit according to claim 1,
wherein the first rib and the second rib face each other in the longitudinal direction, and
wherein, when viewed in the longitudinal direction, the first shape overlaps the second shape.

4. The fixing unit according to claim 1,
wherein the first rib and the second rib face each other in the longitudinal direction, and
wherein, when viewed in the longitudinal direction, the first shape does not overlap the second shape.

5. The fixing unit according to claim 1,
wherein the base surface includes a first intersecting rib extending in the longitudinal direction so as to connect the first rib and the second rib,
wherein the base surface includes a second intersecting rib extending in the longitudinal direction so as to connect the first rib and the second
rib, and
wherein the second intersecting rib faces the first intersecting rib in the conveyance direction.

6. The fixing unit according to claim 5,
wherein, in a case where a portion at which the first rib and the first intersecting rib intersect is referred to as an intersecting portion,
a tip portion of the intersecting portion in the intersecting direction is recessed with respect to a tip portion of the first intersecting rib in the intersecting direction.

7. The fixing unit according to claim 1,
wherein the frame includes a first hole and a second hole that penetrate from the base surface to an exterior of the frame.

8. The fixing unit according to claim 7,
wherein the first hole penetrates from the base surface to the exterior of the frame toward the conveyance direction, and
wherein the second hole penetrates from the base surface to the exterior of the frame toward a direction opposite to the conveyance direction.

9. The fixing unit according to claim 8,
wherein, when viewed in the conveyance direction, the first hole and the second hole overlap.

10. The fixing unit according to claim 7,
wherein the first hole and the second hole are aligned in the longitudinal direction.

11. The fixing unit according to claim 1,
wherein the frame includes a first groove and a second groove that penetrate from the base surface to an exterior of the frame when viewed in the conveyance direction.

12. The fixing unit according to claim 11,
wherein the first groove penetrates from the base surface to the exterior of the frame toward the conveyance direction, and
wherein the second groove penetrates from the base surface to the exterior of the frame toward a direction opposite to the conveyance direction.

13. The fixing unit according to claim 12,
wherein, when viewed in the conveyance direction, the first groove and the second groove overlap.

14. The fixing unit according to claim 11,
wherein the first groove and the second groove are aligned in the longitudinal direction.

15. A fixing unit comprising:
an endless belt;
a heater configured to heat an inner surface of the belt;
a pressure roller including a roller portion formed of rubber and configured to form a nip portion by sandwiching the belt with the heater such that a recording material is conveyed in a conveyance direction through the nip portion; and
a frame formed of resin, configured to support the pressure roller rotatably, and disposed to face the roller portion over a longitudinal direction of the pressure roller,
wherein the frame includes a base surface that faces an outer peripheral surface of the roller portion over the longitudinal direction,
wherein the base surface includes a first rib and a second rib that extend in an intersecting direction intersecting both the conveyance direction and the longitudinal direction,
wherein, when viewed in the longitudinal direction, a tip portion of the first rib and a tip portion of the second rib each have a circular arc shape along the outer peripheral surface of the roller portion,
wherein the first rib and the second rib are aligned in the longitudinal direction,
wherein the base surface includes a first intersecting rib having a first shape and a second intersecting rib having a second shape,
wherein the first intersecting rib and the second intersecting rib are disposed between the first rib and the second rib in the longitudinal direction and extend in the longitudinal direction and in the intersecting direction,
wherein the first intersecting rib and the second intersecting rib are disposed at different positions in the conveyance direction,
wherein the first shape is a first through hole that penetrates the first intersecting rib in the conveyance direction, or a groove portion that is formed in a tip portion of the first intersecting rib in the intersecting direction, and
wherein the second shape is a second through hole that penetrates the second intersecting rib in the conveyance direction, or a groove portion that is formed in a tip portion of the second intersecting rib in the intersecting direction.

16. A fixing unit comprising:
an endless belt;
a heater configured to heat an inner surface of the belt;
a pressure roller including a roller portion formed of rubber and configured to form a nip portion by sandwiching the belt with the heater such that a recording material is conveyed in a conveyance direction through the nip portion;
a frame formed of resin, configured to support the pressure roller rotatably, and disposed to face the roller portion over a longitudinal direction of the pressure roller; and
a temperature detection unit by which a temperature of the pressure roller is detected,
wherein the frame includes a base surface that faces the roller portion over an intersecting direction intersecting both the conveyance direction and the longitudinal direction,
wherein the base surface includes a first rib and a second rib that extend in the intersecting direction,
wherein, when viewed in the longitudinal direction, a tip portion of the first rib and a tip portion of the second rib each have a circular arc shape along an outer peripheral surface of the roller portion,
wherein the first rib and the second rib are aligned in the longitudinal direction,
wherein the frame is formed with a through hole that penetrates from the base surface to an exterior of the frame and that is positioned between the first rib and the second rib, and
wherein the temperature detection unit is disposed to penetrate the through hole and face the pressure roller.

17. The fixing unit according to claim 16,
wherein the temperature detection unit is disposed to come into contact with the pressure roller.

18. The fixing unit according to claim 16,
wherein the temperature detection unit is a non-contact sensor that is disposed not to come into contact with the pressure roller.

19. The fixing unit according to claim 16,
wherein the frame includes an intersecting rib that extends in the longitudinal direction so as to connect the first rib and the second rib,
wherein a tip portion of the intersecting rib is formed with a groove, and
wherein, when viewed in a direction in which the intersecting rib extends toward the frame, the temperature detection unit includes a portion that overlaps the groove.

20. The fixing unit according to claim 19,
wherein the portion is positioned inside the groove.
